(19) United States
(12) Patent Application Publication
(10) Pub. No.: US 2015/0093681 A1
(43) Pub. Date: Apr. 2, 2015

(54) METHOD FOR PRODUCING FUEL CELL ELECTRODE CATALYST, FUEL CELL ELECTRODE CATALYST, AND USES THEREOF

(71) Applicant: SHOWA DENKO K.K., Minato-ku, Tokyo (JP)

(72) Inventors: Ryuji Monden, Tokyo (JP); Takuya Imai, Tokyo (JP); Yuji Ito, Tokyo (JP); Kunchan Lee, Tokyo (JP); Takashi Sato, Tokyo (JP)

(73) Assignee: SHOWA DENKO K.K., Minato-ku, Tokyo (JP)

(21) Appl. No.: 14/390,520

(22) PCT Filed: Mar. 27, 2013
(86) PCT No.: PCT/JP2013/058990

§ 371 Date: Oct. 3, 2014

(30) Foreign Application Priority Data
Apr. 5, 2012 (JP) 2012-086477

(51) Int. Cl. H01M 4/90; H01M 4/88

(52) U.S. Cl. CPC H01M 4/9016; H01M 4/88; H01M 2300/0082; H01M 2008/1095
USPC 429/483; 429/528; 423/365; 502/174

(57) ABSTRACT

An object of the present invention is to provide a fuel cell electrode catalyst with which high durability and a high maximum output density are obtained even when a fuel cell is continuously operated for long time; a method for producing the fuel cell electrode catalyst; a fuel cell in which the catalyst is used; and the like. A method for producing a fuel cell electrode catalyst is provided, the method including: a step of preparing a catalyst precursor comprising each atom of a metal element, carbon, nitrogen, and oxygen, and comprising copper as the metal element; and a contact step of bringing the catalyst precursor and an acid solution into contact with each other to obtain a catalyst.

### TECHNICAL FIELD

The present invention relates to a method for producing a fuel cell electrode catalyst; a fuel cell electrode catalyst; and uses thereof.

### BACKGROUND ART

A polymer electrolyte fuel cell (PEFC) is a fuel cell in the form in which a polymer solid electrolyte is sandwiched between an anode and a cathode, a fuel is supplied to the anode, and oxygen or air is supplied to the cathode, whereby oxygen is reduced at the cathode to produce electricity. As the fuel, hydrogen, methanol, or the like is mainly used.

To enhance a reaction rate in a fuel cell and to enhance the energy conversion efficiency of the fuel cell, a layer containing a catalyst (hereinafter also referred to as a “fuel cell electrode catalyst layer”) has been conventionally disposed on the surface of a cathode (air electrode) or the surface of an anode (fuel electrode) of the fuel cell.

As such a catalyst, noble metals have been generally used, and, among the noble metals, a noble metal stable at a high potential and having a high activity, such as platinum or palladium, has been mainly conventionally used. However, since these noble metals are expensive and limited in resource amount, various substitutable catalysts (e.g. a fuel cell electrode catalyst containing a metal atom, a carbon atom, a nitrogen atom, and an oxygen atom, as disclosed in Patent Literatures 1 to 4 and the like) have been developed.

Among these literatures, Patent Literature 4 discloses a method for producing a fuel cell electrode catalyst, comprising heating a metal carbonitride in an inert gas containing an oxygen gas and bringing the resultant metal carbonitroxide into contact with an acid solution. This production method provides a fuel cell electrode catalyst comprising a metal carbonitroxide, which is superior in durability against repeated change of an electric current and a voltage to a conventional method and has a maximum output density that is inhibited from decreasing even after subjected to such a repetition, and provides a fuel cell in which the catalyst is used.

### CITATION LIST

### Patent Literatures

Patent Literature 1: WO 2009/91043
Patent Literature 2: WO 2010/131634
Patent Literature 3: WO 2011/99493
Patent Literature 4: WO 2012/8249

### SUMMARY OF INVENTION

### Technical Problem

An object of the present invention is to provide a fuel cell electrode catalyst with which high durability and a high maximum output density are obtained even when a fuel cell is continuously operated for long time; a method for producing the fuel cell electrode catalyst; a fuel cell in which the catalyst is used; and the like.

### Solution to Problem

As a result of extensive research, the present inventors found that the above-described problems can be overcome by bringing a catalyst precursor containing copper as a metal element and an acid solution into contact with each other to produce a fuel cell electrode catalyst.

The present invention relates to, for example, the following [1] to [13]:

[1]

A method for producing a fuel cell electrode catalyst, comprising:
a step of preparing a catalyst precursor comprising each atom of a metal element, carbon, nitrogen, and oxygen, and comprising copper as the metal element; and
a contact step of bringing the catalyst precursor and an acid solution into contact with each other to obtain a catalyst.

[2]

The method for producing a fuel cell electrode catalyst according to the above [1], wherein 10 to 99 mol % of the metal element is copper.

[3]

The method for producing a fuel cell electrode catalyst according to the above [1] or [2], further comprising iron as the metal element.

[4]

The method for producing a fuel cell electrode catalyst according to the above [3], wherein 1 to 20 mol % of the metal element is iron.

[5]

The method for producing a fuel cell electrode catalyst according to any of the above [1] to [4], further comprising, as the metal element, at least one selected from the group consisting of sodium, titanium, zirconium, zinc, and tantalum.

[6]

The method for producing a fuel cell electrode catalyst according to the above [1] to [5], wherein the acid solution is an aqueous solution of at least one acid selected from hydrogen chloride, sulfuric acid, citric acid, and acetic acid.

[7]

The method for producing a fuel cell electrode catalyst according to any of the above [1] to [6], wherein the contact step is carried out under the following conditions:
temperature: 15 to 100° C.;
time: 0.1 to 500 hours; and
acid concentration: 0.01 to 15 N.

[8]

A fuel cell electrode catalyst produced by the production method according to any of the above [1] to [7].

[9]

A fuel cell electrode catalyst layer comprising the fuel cell electrode catalyst according to the above [8].

[10]

An electrode comprising a fuel cell electrode catalyst layer and a porous support layer, wherein the fuel cell electrode catalyst layer is the fuel cell electrode catalyst layer according to the above [9].

[11]

A membrane electrode assembly comprising a cathode, an anode, and an electrolyte membrane placed between the cathode and the anode, wherein the cathode and/or the anode is the electrode according to the above [10].

[12]

A fuel cell comprising the membrane electrode assembly according to the above [11].

[13]

The fuel cell according to the above [12], which is a polymer electrolyte fuel cell.

### Advantageous Effect of Invention

According to the present invention, there are provided a fuel cell electrode catalyst with which high durability and a high maximum output density are obtained even when a fuel cell is continuously operated for long time; a method for producing the fuel cell electrode catalyst; a fuel cell in which the catalyst is used; and the like.

### BRIEF DESCRIPTION OF THE DRAWINGS

FIG. 1 is a graph of evaluation of the durability of the single cells of polymer electrolyte fuel cells of Comparative Example 1 and Example 1.

FIG. 2 is a graph of evaluation of the durability of the single cells of polymer electrolyte fuel cells of Comparative Example 2 and Example 2.

FIG. 3 is a graph of evaluation of the durability of the single cells of polymer electrolyte fuel cells of Comparative Example 3, Example 3, and Comparative Example 7.

FIG. 4 is a graph of evaluation of the durability of the single cells of polymer electrolyte fuel cells of Comparative Example 4, Example 4, and Comparative Example 8.

FIG. 5 is a graph of evaluation of the durability of the single cells of polymer electrolyte fuel cells of Comparative Example 5 and Example 5.

FIG. 6 is a graph of evaluation of the durability of the single cells of polymer electrolyte fuel cells of Comparative Example 6 and Example 6.

### DESCRIPTION OF EMBODIMENTS

### Method for Producing Fuel Cell Electrode Catalyst

The method for producing a fuel cell electrode catalyst according to the present invention comprises:
a step of preparing a catalyst precursor comprising each atom of a metal element, carbon, nitrogen, and oxygen, and comprising copper as the metal element; and
a contact step of bringing the catalyst precursor and an acid solution into contact with each other to obtain a catalyst. In the present specification, an atom and an ion are not strictly distinguished from each other, and are referred to as an “atom”.

<Step of Preparing Catalyst Precursor>

In the step of preparing a catalyst precursor, a catalyst precursor comprising each atom of a metal element, carbon, nitrogen, and oxygen, and comprising copper as the metal element is prepared.

The metal element preferably further includes iron. The metal element may also include at least one metal element (M3) selected from the group consisting of sodium, titanium, zirconium, zinc, and tantalum.

The rate of copper in the metal elements contained in the catalyst precursor is preferably 10 to 99 mol %, further preferably 50 to 95 mol %, the rate of iron is preferably 1 to 20 mol %, further preferably 4 to 15 mol %, and the rate of the metal element (M3) is preferably 85 mol % or less, further preferably 0.1 to 46 mol %.

Preferred examples of the catalyst precursor include a catalyst precursor produced by a production method (hereinafter also referred to as a “method (A) for producing a catalyst precursor”) comprising:
a step (1) of mixing at least a metal compound (1), a nitrogen-containing organic compound (2), and a solvent to obtain a solution (hereinafter also referred to as a “solution for producing a precursor”),
a step (2) of removing the solvent from the solution for producing a precursor, and
a step (3) of heat-treating a solid residue obtained in the step (2) (preferably at a temperature of 500 to 1100° C.) to obtain
a catalyst precursor;
a portion or the entirety of the metal compound (1) containing copper; and
among the components used in the step (1), at least one component other than the solvent having an oxygen atom (i.e., at least one of the compound (1), the compound (2), and the compound (3) has an oxygen atom in the case of using the compound (3) described below while at least one of the compound (1) and the compound (2) has an oxygen atom in the case of not using the compound (3)).

The method (A) for producing a catalyst precursor will be described in detail below.

(Step (1))

In the step (1), at least a metal compound (1), a nitrogen-containing organic compound (2), a solvent, and optionally a compound (3) described below are mixed to obtain a solution for producing a precursor.

Exemplary mixing procedures are:
procedure (i): putting a solvent in one container, adding and dissolving thereto the metal compound (1), the nitrogen-containing organic compound (2), and optionally the compound (3), and mixing them; and
procedure (ii): preparing a solution of the metal compound (1) and a solution of the nitrogen-containing organic compound (2) and optionally the compound (3), and mixing them.

When a solvent does not allow each component to have high solubility therein, the procedure (ii) is preferable. When the metal compound (1) is, for example, a metal halide described later, the procedure (i) is preferable, while when the metal compound (1) is, for example, a metal alkoxide or a metal complex described later, the procedure (ii) is preferable.

The mixing operation is preferably performed with stirring, in order to increase the dissolution rate of each component in a solvent.

When a plurality of solutions are prepared and these solutions are then mixed to obtain a catalyst precursor solution, it is preferable that one solution is supplied to the other solution at a constant rate with a pump or the like.

It is also preferable that the solution of the metal compound (1) is added little by little to the solution of the nitrogen-containing organic compound (2) or the solution of the nitrogen-containing organic compound (2) and the compound (3) (i.e., the whole amount is not added at a time).

The solution for producing a precursor is considered to contain a reaction product of the metal compound (1) and the nitrogen-containing organic compound (2). The solubility of this reaction product in a solvent also varies depending on the combination of the metal compound (1), the nitrogen-containing organic compound (2), a solvent, and the like.

Therefore, when the metal compound (1) is, for example, a metal alkoxide or a metal complex, it is preferable that the solution for producing a precursor does not contain a precipitate or a dispersoid, although this depends on the type of solvent and the type of the nitrogen-containing organic compound (2), and, even if the precipitate or the dispersoid are contained, it is preferable that the amount thereof is small (for example, the amount is 10 mass % or less, preferably 5 mass % or less, more preferably 1 mass % or less of the total amount of the solution).

On the other hand, when the metal compound (1) is, for example, a metal halide, a precipitate which is considered to be the reaction product of the metal compound (1) and the nitrogen-containing organic compound (2) is easily generated in the solution for producing a precursor, although this depends on the type of solvent and the type of the nitrogen-containing organic compound (2).

In the step (1), the metal compound (1), the nitrogen-containing organic compound (2), a solvent, and optionally the compound (3) may also be put in a pressure-applicable container such as an autoclave and mixed with being pressurized at a pressure of ordinary pressure or more.

The temperature at which the metal compound (1), the nitrogen-containing organic compound (2), a solvent, and optionally the compound (3) are mixed is, for example, 0 to 60° C. In view of a complex being considered to be formed from the metal compound (1) and the nitrogen-containing organic compound (2), if this temperature is excessively high and the solvent contains water, it is considered that the complex is hydrolyzed to cause a hydroxide to precipitate, leading to the failure to obtain an excellent catalyst using the catalyst precursor, whereas if this temperature is excessively low, it is considered that the metal compound (1) is precipitated before the complex is formed, leading to the failure to obtain an excellent catalyst using the catalyst precursor.

<Metal Compound (1)>

A portion or the entirety of the metal compound (1) contains copper.

The metal compound (1) preferably contains iron and may also contains at least one metal element (M3) selected from the group consisting of sodium, titanium, zirconium, zinc, and tantalum.

The metal compound (1) preferably contains at least one atom selected from an oxygen atom and halogen atoms, and specific examples thereof include metal phosphates, metal sulfates, metal nitrates, metal organic acid salts, metal acid halides (intermediate hydrolysates of metal halides), metal alkoxides, metal halides, metal halates, metal hypohalites, and metal complexes (where compounds of sodium include hydroxides, carbonates, sulfates, nitrates, acetates, chlorides, and the like). These may be used singly or in combination of two or more kinds.

As the metal alkoxides, isopropoxide, ethoxide, and butoxide of the metals are preferred. The metal alkoxide may have one kind of alkoxy group or may have two or more kinds of alkoxy groups.

As the metal compound (1) containing an oxygen atom, metal alkoxides, acetylacetonate complexes, metal acid chlorides, metal sulfates, and metal nitrates are preferred; in view of a cost, metal alkoxides and acetylacetonate complexes are more preferred; and, from the viewpoint of solubility in a solvent, metal alkoxides and acetylacetonate complexes are preferred.

As the metal halides, metal chlorides, metal bromides, and metal iodides are preferred. As the metal acid halides, metal acid chlorides, metal acid bromides, and metal acid iodides are preferred.

As the metal perhalates, metal perchlorates are preferred. As the metal hypohalites, metal hypochlorites are preferred.

Of the metal compounds (1), specific examples of the compound containing copper include copper compounds such as copper(II) ethoxide, copper(II) isopropoxide, copper(II) butoxide, copper(II) pentoxide, copper(II) acetylacetonate, bis(diethylamino) copper, bis(2,2,6,6-tetramethyl-3,5-heptanedione)copper, copper(II) hexafluoroacetylacetonate, bis-1-methoxy-2-methyl-2-propoxy copper(II), copper dichloride, copper oxychloride, copper dibromide, copper oxybromide, copper diiodide, and copper oxyiodide. These compounds may be used singly or in combination of two or more kinds.

Of these compounds, in view of allowing the resultant catalyst to be fine particles having a uniform particle diameter and to have high activity, preferred are:
copper dichloride, copper oxychloride, copper(II) ethoxide, copper(II) isopropoxide, copper(II) butoxide, copper(II) acetylacetonate; and
further preferred are:
copper dichloride, copper oxychloride, copper(II) ethoxide, copper(II) isopropoxide, copper(II) acetylacetonate.

Of the metal compounds (1), specific examples of the compound containing iron include iron compounds such as iron(III) ethoxide, iron(III) isopropoxide, iron(III) butoxide, iron(III) pentoxide, iron(III) acetylacetonate, iron(III) isopropoxide acetylacetonates (Fe(acac)(O-iPr)₂, Fe(acac)₂(O-iPr)), tris(diethylamino)iron, tris(2,2,6,6-tetramethyl-3,5-heptanedione)iron, iron(III) hexafluoroacetylacetonate, tri-1-methoxy-2-methyl-2-propoxy iron(III), iron trichloride, iron dichloride, iron oxychloride, iron tribromide, iron dibromide, iron oxybromide, iron triiodide, iron diiodide, iron oxyiodide, iron(III) sulfate, iron(II) sulfide, iron(III) sulfide, potassium ferrocyanide, potassium ferricyanide, ammonium ferrocyanide, ammonium ferricyanide, iron ferrocyanide, iron(II) nitrate, iron(III) nitrate, iron(II) oxalate, iron(III) oxalate, iron(II) phosphate, iron(III) phosphate, ferrocene, iron(II) oxide, iron(III) oxide, triiron tetraoxide, iron(II) acetate, and iron(III) citrate. These compounds may be used singly or in combination of two or more kinds.

Of these compounds, in view of allowing the resultant catalyst to be fine particles having a uniform particle diameter and to have high activity, preferred are:
iron trichloride, iron dichloride, iron oxychloride, iron(III) ethoxide, iron(III) isopropoxide, iron(III) butoxide, iron(III) acetylacetonate, iron(III) isopropoxide acetylacetonates (Fe(acac)(O-iPr)₂, Fe(acac)₂(O-iPr)), potassium ferrocyanide, potassium ferricyanide, ammonium ferrocyanide, ammonium ferricyanide, iron(II) acetate, iron(II) nitrate; and
further preferred are:
iron trichloride, iron dichloride, iron(III) ethoxide, iron(III) isopropoxide, iron(III) butoxide, iron(III) acetylacetonate, potassium ferrocyanide, potassium ferricyanide, ammonium ferrocyanide, ammonium ferricyanide, iron(II) acetate.

Of the metal compounds (1), specific examples of the compound containing the metal element (M3) include:
sodium compounds such as sodium hydroxide, sodium carbonate, sodium sulfate, sodium nitrate, sodium acetate, and sodium chloride;
titanium compounds such as titanium tetraethoxide, titanium tetraisopropoxide, titanium tetrabutoxide, titanium tetrapentoxide, titanium tetraacetylacetonate, titanium diisopropoxide diacetylacetonates (Ti(acac)₂(O-iPr)₂), titanium oxydiacetylacetonate, bis[tris(2,4-pentanedionato)titanium(IV)]hexachlorotitanate(IV) ([Ti(acac)₃]₂-[TiCl₆]), titanium tetrachloride, titanium trichloride, titanium oxychloride, titanium tetrabromide, titanium tribromide, titanium oxybromide, titanium tetraiodide, titanium triiodide, and titanium oxyiodide;
zirconium compounds such as zirconium tetraethoxide, zirconium tetraisopropoxide, zirconium tetrabutoxide, zirconium tetrapentoxide, zirconium tetraacetylacetonate, zirconium diisopropoxide diacetylacetonate (Zr(acac)₂(O-iPr)₂). tetrakis(diethylamino)zirconium, tetrakis(2,2,6,6-tetramethyl-3,5-heptanedione)zirconium, zirconium(IV) hexafluoroacetylacetonate, tetra-1-methoxy-2-methyl-2-propoxyzirconium (IV), zirconium tetrachloride, zirconium oxychloride, zirconium tetrabromide, zirconium oxybromide, zirconium tetraiodide, and zirconium oxyiodide;
zinc compounds such as zinc ethoxide, zinc isopropoxide, zinc butoxide, zinc pentoxide, zinc acetylacetonate, bis(diethylamino)zinc, bis(2,2,6,6-tetramethyl-3,5-heptanedione)zinc, zinc hexafluoroacetylacetonate, bis-1-methoxy-2-methyl-2-propoxy zinc, zinc dichloride, zinc oxychloride, zinc dibromide, zinc oxybromide, zinc diiodide, and zinc oxyiodide; and
tantalum compounds such as tantalum pentaethoxide, tantalum pentaisopropoxide, tantalum pentabutoxide, tantalum pentapentoxide, tantalum tetraethoxyacetylacetonate, tantalum diisopropoxide diacetylacetonate (Ta(acac)₂(O-iPr)₂), pentakis(diethylamino)tantalum, tantalum pentachloride, tantalum oxychloride, tantalum pentabromide, tantalum oxybromide, tantalum pentaiodide, and tantalum oxyiodide. These compounds may be used singly or in combination of two or more kinds.

Of these compounds, in view of allowing the resultant catalyst to be fine particles having a uniform particle diameter and to have high activity, preferred are:
sodium hydroxide, sodium carbonate, sodium acetate, sodium chloride,
titanium tetraisopropoxide, titanium tetraacetylacetonate, titanium diisopropoxide diacetylacetonate (Ti(acac)₂(O-iPr)₂),
zirconium tetraethoxide, zirconium tetrachloride, zirconium oxychloride, zirconium tetraisopropoxide, zirconium tetrabutoxide, zirconium tetraacetylacetonate, zirconium diisopropoxide diacetylacetonate (Zr(acac)₂(O-iPr)₂),
zinc dichloride, zinc oxychloride, zinc ethoxide, zinc isopropoxide, zinc butoxide, zinc acetylacetonate,
tantalum pentaethoxide, tantalum pentachloride, tantalum oxychloride, tantalum pentaisopropoxide, tantalum tetraethoxyacetylacetonate (Ta(acac)(O—C₂H₅)₄), and tantalum diisopropoxide triacetylacetonate (Ta(acac)₃(O-iPr)₂); and
further preferred are:
sodium hydroxide, sodium carbonate, sodium acetate, sodium chloride,
titanium tetrachloride, titanium tetraisopropoxide, titanium tetraacetylacetonate,
zirconium tetrachloride, zirconium oxychloride, zirconium tetraisopropoxide, zirconium tetrabutoxide,
zinc dichloride, zinc ethoxide, zinc isopropoxide, zinc butoxide, zinc acetylacetonate,
tantalum pentachloride, and tantalum pentaisopropoxide.

The rate of copper in the metal elements contained in all the metal compounds (1) is preferably 10 to 99 mol %, further preferably 50 to 95 mol %, the rate of iron is preferably 1 to 20 mol %, further preferably 4 to 15 mol %, and the rate of the metal element (M3) is preferably 85 mol % or less, further preferably 0.1 to 46 mol %.

<Nitrogen-Containing Organic Compound (2)>

As the nitrogen-containing organic compound (2), preferred is a compound capable of becoming a ligand that can be coordinated to a metal atom in the metal compound (1) (preferably, a compound capable of forming a mononuclear complex); and further preferred is a compound capable of becoming a multidentate ligand (preferably, a bidentate ligand or a tridentate ligand) (compound capable of forming a chelate).

The nitrogen-containing organic compounds (2) may be used singly or in combination of two or more kinds.

The nitrogen-containing organic compound (2) preferably has a functional group such as amino group, nitrile group, imido group, imine group, nitro group, amide group, azido group, aziridine group, azo group, isocyanate group, isothiocyanate group, oxime group, diazo group, or nitroso group, or a ring such as pyrrole ring, porphyrin ring, pyrrolidine ring, imidazole ring, triazole ring, pyridine ring, piperidine ring, pyrimidine ring, pyrazine ring, or purine ring (these functional groups and rings are also collectively referred to as “nitrogen-containing molecular group”).

The nitrogen-containing organic compound (2), by containing the nitrogen-containing molecular group in the molecule, is considered to be more strongly coordinated to a metal atom derived from the metal compound (1) after subjected to the mixing in the step (1).

Among the nitrogen-containing molecular group, amino group, imine group, amide group, pyrrole ring, pyridine ring, and pyrazine ring are more preferred; amino group, imine group, pyrrole ring, and pyrazine ring are further preferred; and amino group and pyrazine ring are particularly preferred because of allowing the catalyst obtained after further subjected to a contact step described below to have particularly high activity.

Specific examples of the nitrogen-containing organic compound (2), wherein the compound does not contain an oxygen atom, include melamine, ethylenediamine, triazole, acetonitrile, acrylonitrile, ethyleneimine, aniline, pyrrole, polyethyleneimine, salts thereof, and the like. Of these, ethylenediamine and ethylenediamine dihydrochloride are preferred because of allowing the catalyst obtained after further subjected to the contact step described below to have high activity.

The nitrogen-containing organic compound (2) preferably further has hydroxyl group, carboxyl group, aldehyde group, acid halide group, sulfo group, phosphate group, ketone group, ether group, or ester group (these are also collectively referred to as “oxygen-containing molecular group”). The nitrogen-containing organic compound (2), by containing the oxygen-containing molecular group in the molecule, is considered to be more strongly coordinated to a metal atom derived from the metal compound (1) after subjected to the mixing in the step (1).

Among the oxygen-containing molecular group, carboxyl group and aldehyde group are particularly preferred because of allowing the catalyst obtained after further subjected to the contact step described below to have particularly high activity.

As the nitrogen-containing organic compound (2) that contains an oxygen atom in the molecule, compounds having the nitrogen-containing molecular group and the oxygen-containing molecular group are preferred. Such compounds are considered to be particularly strongly coordinated to a metal atom derived from the metal compound (1) after subjected to the step (1).

As the compounds having the nitrogen-containing molecular group and the oxygen-containing molecular group, amino acids having amino group and carboxyl group, and derivatives thereof are preferable.

As the amino acids, preferred are alanine, arginine, asparagine, asparagine acid, cysteine, glutamine, glutamic acid, glycine, histidine, isoleucine, leucine, lysine, methionine, phenylalanine, serine, threonine, tryptophan, tyrosine, valine, norvaline, glycylglycine, triglycine, and tetraglycine; because of allowing the catalyst obtained after further subjected to the contact step described below to have high activity, alanine, glycine, lysine, methionine, and tyrosine are more preferred; and because of allowing the catalyst obtained after further subjected to the contact step described below to have extremely high activity, alanine, glycine, and lysine are particularly preferred.

Specific examples of the nitrogen-containing organic compound (2) that contains an oxygen atom in the molecule include, in addition to the above-described amino acids and the like, acylpyrroles such as acetylpyrrole, pyrrolecarboxylic acid, acylimidazoles such as acetylimidazole, carbonyldiimidazole, imidazolecarboxylic acid, pyrazole, acetanilide, pyrazinecarboxylic acid, piperidinecarboxylic acid, piperazinecarboxylic acid, morpholine, pyrimidinecarboxylic acid, nicotinic acid, 2-pyridinecarboxylic acid, 2,4-pyridinedicarboxylic acid, 8-quinolinol, and polyvinylpyrrolidone; because of allowing the catalyst obtained after further subjected to the contact step described below to have high activity, preferred are compounds capable of becoming a bidentate ligand: specifically, preferred are pyrrole-2-carboxylic acid, imidazole-4-carboxylic acid, 2-pyrazinecarboxylic acid, 2-piperidinecarboxylic acid, 2-piperazinecarboxylic acid, nicotinic acid, 2-pyridinecarboxylic acid, 2,4-pyridinedicarboxylic acid, and 8-quinolinol; and more preferred are 2-pyrazinecarboxylic acid and 2-pyridinecarboxylic acid.

The ratio (B/A) of the total number B of carbon atoms of the nitrogen-containing organic compound (2) used in the step (1) to the total number A of atoms of a metal element of the metal compound (1) used in the step (1) is preferably 200 or less, more preferably 150 or less, further preferably 80 or less, particularly preferably 30 or less in terms of allowing the heat treatment in the step (3) to be performed while decreasing components eliminating as carbon compounds such as carbon dioxide and carbon monoxide, i.e., decreasing an emission gas during production of a catalyst precursor; and the ratio is preferably 1 or more, more preferably 2 or more, further preferably 3 or more, particularly preferably 5 or more in terms of obtaining a catalyst having good activity.

The ratio (C/A) of the total number C of nitrogen atoms of the nitrogen-containing organic compound (2) used in the step (1) to the total number A of atoms of a metal element of the metal compound (1) used in the step (1) is preferably 28 or less, more preferably 17 or less, further preferably 12 or less, particularly preferably 8.5 or less in terms of obtaining a catalyst having good activity after further subjected to the contact step described below; and the ratio is preferably 1 or more, more preferably 2.5 or more, further preferably 3 or more, particularly preferably 3.5 or more in terms of obtaining a catalyst having good activity after further subjected to the contact step described below.

<Compound (3)>

In the production method of the present invention, an electrode catalyst having further high catalytic activity can be produced after further subjected to the contact step described below by further also mixing the compound (3) containing fluorine (in a chemical structure) in the step (1).

Specific examples of the compound (3) containing fluorine (in a chemical structure) include alcohols containing a fluorine atom, ethers containing a fluorine atom, amines containing a fluorine atom, carboxylic acids containing a fluorine atom, boric acid derivatives containing a fluorine atom, phosphoric acid derivatives containing a fluorine atom, and sulfonic acid derivatives containing a fluorine atom.

Examples of the alcohols containing a fluorine atom and derivatives thereof include:
saturated or unsaturated aliphatic alcohols in which all or some of the hydrogen atoms of a hydrocarbon group are substituted by a fluorine atom (the number of carbon atoms is, for example, 1 to 30), e.g., fluoroalkyl alcohols such as nonacosadecafluorotetradecyl alcohol, heptacosadecafluorotridecyl alcohol, pentacosadecafluorododecyl alcohol, henicosadecafluorodecyl alcohol, heptadecafluorooctyl alcohol, tridecafluorohexyl alcohol, nonafluorobutyl alcohol, pentafluoroethyl alcohol, trifluoromethyl alcohol, 2,2,2-trifluoroethyl alcohol, 6-(perfluorohexyl)hexanol, 2,5-di(trifluoromethyl)-3,6-dioxoundecafluorononanol, perfluoro-methylethylhexanol, dodecafluoroheptanol, octafluorohexanediol, and dodecafluorooctanediol.

These may be used singly or in combination of two or more kinds.

The alcohols containing a fluorine atom or the derivatives thereof preferably have three or more fluorine atoms in one molecule.

The ethers containing a fluorine atom are represented by the formula: R^{f}—O—R^{f}′ (R^{f} and R^{f}′ are each independently hydrocarbon groups in which all or some of hydrogen atoms are substituted by a fluorine atom). Examples of R^{f} and R^{f}′ include fluoroalkyl groups such as nonacosadecafluorotetradecyl group, heptacosadecafluorotridecyl group, pentacosadecafluorododecyl group, tricosadecafluoroundecyl group, henicosadecafluorodecyl group, nonadecafluorononyl group, heptadecafluorooctyl group, pentadecafluoroheptyl group, tridecafluorohexyl group, undecafluoropentyl group, nonafluorobutyl group, heptafluoropropyl group, pentafluoroethyl group, trifluoromethyl group, and 2,2,2-trifluoroethyl group, and R^{f} and R^{f}′ may also be groups having aryl group (e.g., phenyl group and pyridyl group).

Examples of the ethers containing a fluorine atom include:
an alternating copolymer having a structure represented by the formula: [—[(CF₂—CF₂)—(CH₂—CH(OR))ₙ—] and obtained by alternating copolymerization of tetrafluoroethylene (CF₂═CF₂) and vinyl ether (CH₂═CHOR) (e.g., LUMIFLON (registered trademark) (ASAHI GLASS CO., LTD.)),
fluorine polyaryletherketone, fluorine polycyanoarylether, 3-(2-perfluorohexylethoxy)-1,2-dihydroxypropane,
   a compound represented by

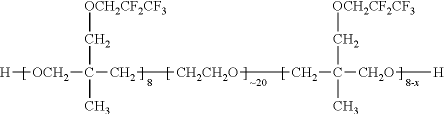

a compound represented by

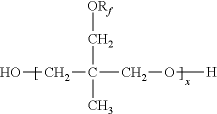

wherein R_{f}═—CH₂CF₃ or —CH₂CF₂CF₃,
NOVEC™ HFE (trade name) (hydrofluoroether, RYOKO CHEMICAL CO., LTD.), and NOVEC™ HFE (trade name) (hydrofluoroether, 3M) as commercially available products.

As the ethers containing a fluorine atom, SURFLON (registered trademark) S-241, S-242, S-243, and S-420 (AGC SEIMI CHEMICAL CO., LTD.) and FUTARGENT (registered trademark) 250 (NEOS Co., Ltd.), which are fluorine-containing surfactants, and the like may be used.

These may be used singly or in combination of two or more kinds.

The ethers containing a fluorine atom or derivatives thereof preferably have three or more fluorine atoms in one molecule.

Examples of the amines containing a fluorine atom and derivatives thereof include:
saturated or unsaturated aliphatic amines represented by the formula: R^{f}—NR¹R² (R^{f} is a saturated or unsaturated aliphatic hydrocarbon group in which all or some of hydrogen atoms are substituted by a fluorine atom; R¹ and R² are each independently hydrogen atoms, or hydrocarbon groups having 1 to 10 carbon atoms in which all or some of hydrogen atoms may be substituted by a fluorine atom; and the number of carbon atoms of R^{f} is, for example, 1 to 30), e.g., fluoroalkylamines such as nonacosadecafluorotetradecylamine, heptacosadecafluorotridecylamine, pentacosadecafluorododecylamine, henicosadecafluorodecylamine, heptadecafluorooctylamine, pentadecafluoroheptylamine, undecafluoropentylamine, heptafluoropropylamine, pentafluoroethylamine, trifluoromethylamine, and 2,2,2-trifluoroethylamine; and
salts of the fluoroalkylamines (general formula: A⁺[R₄N]⁻; A⁺ represents, for example, sodium ion, potassium ion, or ammonium ion; and R each independently represents a fluoroalkyl group in the fluoroalkylamines), e.g., hydrochlorides, sulfates, carboxylates, and phosphates.

As the amines containing a fluorine atom or salts thereof, SURFLON (registered trademark) S-221 (AGO SEIMI CHEMICAL CO., LTD.) and FUTARGENT (registered trademark) 300 (NEOS Co., Ltd.), which are fluorine-containing surfactants, and the like may be used.

These may be used singly or in combination of two or more kinds.

The amines containing a fluorine atom or the derivatives thereof preferably have three or more fluorine atoms in one molecule.

Examples of the carboxylic acids containing a fluorine atom and derivatives thereof include:
saturated or unsaturated aliphatic carboxylic acids in which all or some of hydrogen atoms of a hydrocarbon group are substituted by a fluorine atom (the number of carbon atoms is, for example, 1 to 30), e.g., fluoroalkylcarboxylic acids such as nonacosadecafluorotetradecanoic acid, heptacosadecafluorotridecanoic acid, pentacosadecafluorododecanoic acid, tricosadecafluoroundecanoic acid, henicosadecafluorodecanoic acid, heptadecafluorooctanoic acid, tridecafluorohexanoic acid, nonafluorobutanoic acid, pentafluoroacetic acid, trifluoroacetic acid, 2,2,2-trifluoroethylcarboxylic acid, tetrafluorocitric acid, hexafluoroglutamic acid, and octafluoroadipic acid;
aromatic carboxylic acids in which some or all of hydrogen atoms in an aryl group are substituted by a fluoroalkyl group in the fluoroalkylcarboxylic acids, e.g., trifluoromethylbenzoic acid, trifluoromethylsalicylic acid, and trifluoromethylnicotinic acid;
esters of the aliphatic carboxylic acids (e.g., methyl esters, ethyl esters, aryl esters (e.g., phenyl ester), and esters of the alcohols containing a fluorine atom), e.g., methyl heptadecafluorooctanoate, ethyl heptadecafluorooctanoate, phenyl heptadecafluorooctanoate, and heptadecafluorooctyl heptadecafluorooctanoate ester;
fluorine polyarylether polyarylether ester;
salts of the aliphatic carboxylic acids (e.g., sodium salts, potassium salts, ammonium salts, alkylammonium (e.g., methylammonium, trimethylammonium, ethylammonium, diethylammonium, and triethylammonium) salts, and salts of the fluoroalkylamines), e.g., ammonium heptadecafluorooctanoate, sodium heptadecafluorooctanoate, and triethylammonium heptadecafluorooctanoate;
amides of the aliphatic carboxylic acids (general formula: R^{f}—CO—NR¹R²; R^{f} represents a fluoroalkyl group in the aliphatic carboxylic acids; and R¹ and R² each independently represent a hydrocarbon group having 1 to 10 carbon atoms (e.g., methyl group, ethyl group, and phenyl group), in which all or some of hydrogen atoms may be substituted by a fluorine atom, e.g., heptadecafluorooctanoic acid amide, heptadecafluorooctanoic acid diethylamide, and heptadecafluorooctanoic acid heptadecafluorooctyl amide;
fluorine polyarylether amide;
fluorine polyarylether imide;
acid anhydrides of the aliphatic carboxylic acids (the general formula: (R^{f}—CO)₂O; R^{f} represents a fluoroalkyl group in the aliphatic carboxylic acids), e.g., heptadecafluorooctanoic acid anhydride;
amino acids (e.g., amino acids having a fluoroalkyl group in the fluoroalkylcarboxylic acids); and
organic compounds having a substituent that can be derived from the carboxylic acids or derivatives thereof (the organic compounds may be high-molecular compounds).

As the carboxylic acids containing a fluorine atom or the derivatives thereof, SURFLON (registered trademark) S-211 and S-212 (based on amino acid) (AGC SEIMI CHEMICAL CO., LTD.) and FUTARGENT (registered trademark) 501 and 150 (NEOS Co., Ltd.), which are fluorine-containing surfactants, and the like may be used.

These may be used singly or in combination of two or more kinds.

The carboxylic acids containing a fluorine atom or the derivatives thereof preferably have three or more fluorine atoms in one molecule.

Examples of the boric acid derivatives containing fluorine include:
quaternary ammonium tetrafluoroborates (e.g., tetra-n-butylammonium tetrafluoroborate, tetramethylammonium tetrafluoroborate, tetraethylammonium tetrafluoroborate, tetrabutylammonium tetrafluoroborate, ethyltrimethylammonium tetrafluoroborate, diethyldimethylammonium tetrafluoroborate, triethylmethylammonium tetrafluoroborate, methyltripropylammonium tetrafluoroborate, trimethylpropylammonium tetrafluoroborate, ethyldimethylpropylammonium tetrafluoroborate, triethylpropylammonium tetrafluoroborate, dimethyldipropylammonium tetrafluoroborate, ethylmethyldipropylammonium tetrafluoroborate, trimethylbutylammonium tetrafluoroborate, diethylmethylbutylammonium tetrafluoroborate, triethylbutylammonium tetrafluoroborate, dimethyldibutylammonium tetrafluoroborate, ethylmethyldibutylammonium tetrafluoroborate, and hexyltrimethylammonium tetrafluoroborate (the propyls include n-propyl and i-propyl; and the butyls include n-butyl, i-butyl, s-butyl, and t-butyl)),
quaternary pyridinium tetrafluoroborates (e.g., pyridinium tetrafluoroborate, 1-methylpyridinium tetrafluoroborate, 2-bromo-1-ethylpyridinium tetrafluoroborate, and 1-butylpyridinium tetrafluoroborate), and
quaternary imidazolium tetrafluoroborates (e.g., 1,3-dimethylimidazolium tetrafluoroborate, 1-ethyl-3-methylimidazolium tetrafluoroborate, 1,3-diethylimidazolium tetrafluoroborate, 1,2-dimethyl-3-ethylimidazolium tetrafluoroborate, 1,2-dimethyl-3-propylimidazolium tetrafluoroborate, and 1-butyl-3-methylimidazolium tetrafluoroborate);
fluoroalkylboric acids, of which all or some of the hydrogen atoms of the alkyl group are substituted by a fluorine atom (e.g., nonacosadecafluorotetradecylboric acid, heptacosadecafluorotridecylboric acid, pentacosadecafluorododecylboric acid, henicosadecafluorodecylboric acid, heptadecafluorooctylboric acid, tridecafluorohexylboric acid, nonafluorobutylboric acid, pentafluoroethylboric acid, trifluoromethylboric acid, and 2,2,2-trifluoroethylboric acid);
monoesters and diesters (e.g., methyl esters, and ethyl esters) of the fluoroalkylboric acids; and
salts of the fluoroalkylboric acids (e.g., sodium salts, potassium salts, ammonium salts, methylammonium salts, dimethylammonium salts, trimethylammonium salts, and triethylammonium salts).

As the boric acid derivatives containing fluorine, preferred are: ammonium tetrafluoroborate, methylammonium tetrafluoroborate, dimethylammonium tetrafluoroborate, trimethylammonium tetrafluoroborate, ethylammonium tetrafluoroborate, diethylammonium tetrafluoroborate, triethylammonium tetrafluoroborate, butylammonium tetrafluoroborate, tetra-n-butylammonium tetrafluoroborate, tetramethylammonium tetrafluoroborate, tetraethylammonium tetrafluoroborate, tetrapropylammonium tetrafluoroborate, tetrabutylammonium tetrafluoroborate, and 1-butyl-3-methylimidazolium tetrafluoroborate; and more preferred are: ammonium tetrafluoroborate, butylammonium tetrafluoroborate, tetraethylammonium tetrafluoroborate, and 1-butyl-3-methylimidazolium tetrafluoroborate.

Examples of the phosphoric acid derivatives containing fluorine include:
hexafluorophosphate, for example, quaternary ammonium hexafluorophosphates (e.g., tetra-n-butylammonium hexafluorophosphate, tetramethylammonium hexafluorophosphate, tetraethylammonium hexafluorophosphate, tetrapropylammonium hexafluorophosphate, ethyltrimethylammonium hexafluorophosphate, diethyldimethylammonium hexafluorophosphate, triethylmethylammonium hexafluorophosphate, trimethylpropylammonium hexafluorophosphate, ethyldimethylpropylammonium hexafluorophosphate, triethylpropylammonium hexafluorophosphate, dimethyldipropylammonium hexafluorophosphate, ethylmethyldipropylammonium hexafluorophosphate, trimethylbutylammonium hexafluorophosphate, ethyldimethylbutylammonium hexafluorophosphate, triethylbutylammonium hexafluorophosphate, tripropylbutylammonium hexafluorophosphate, dimethyldibutylammonium hexafluorophosphate, ethylmethyldibutylammonium hexafluorophosphate, and hexyltrimethylammonium tetrafluorophosphate (the propyls include n-propyl, and i-propyl; and the butyls include n-butyl, i-butyl, s-butyl, and t-butyl),
quaternary pyridinium hexafluorophosphates (e.g., pyridinium hexafluorophosphate, 1-methylpyridinium hexafluorophosphate, and 2-bromo-1-ethylpyridinium hexafluorophosphate), and
quaternary imidazolium tetrafluorophosphates (e.g., 1,3-dimethylimidazolium tetrafluorophosphate, 1-ethyl-3-methylimidazolium tetrafluorophosphate, 1,3-diethylimidazolium tetrafluorophosphate, 1,2-dimethyl-3-ethylimidazolium tetrafluorophosphate, 1,2-dimethyl-3-propylimidazolium tetrafluorophosphate, and 1-butyl-3-methylimidazolium tetrafluorophosphate);
hexafluorophosphoric acids;
salts of the hexafluorophosphoric acids (e.g., sodium salts, potassium salts, ammonium salts, alkylammonium (e.g., methylammonium, dimethylammonium, trimethylammonium, ethylammonium, diethylammonium, and triethylammonium) salts);
fluoroalkyl phosphate esters represented by the general formula: (RO)ₙP═O (wherein n is 1 to 3; and R is a fluoroalkyl group in which all or some of the hydrogen atoms of an alkyl group are substituted by a fluorine atom (e.g., nonacosadecafluorotetradecyl group, nonacosadecafluorotetradecyl group, heptacosadecafluorotridecyl group, pentacosadecafluorododecyl group, tricosadecafluoroundecyl group, henicosadecafluorodecyl group, nonadecafluorononyl group, heptadecafluorooctyl group, pentadecafluoroheptyl group, tridecafluorohexyl group, undecafluoropentyl group, nonafluorobutyl group, heptafluoropropyl group, pentafluoroethyl group, trifluoromethyl group, and 2,2,2-trifluoroethyl group));
fluoroalkyl phosphoric amide represented by the general formula: (RN)₃P═O, (RN)₂P═O(OH), or (RN)P═O(OH)₂ (wherein R represents the fluoroalkyl group);
fluoroalkyl phosphorous acid represented the general formula (RO)₃P, (RO)₂(OH)P, or (RO)(OH)₂P (wherein the fluoroalkyl group is represented);
fluoroalkyl phosphite amide represented by the general formula (RN)₃P, (RN)₂P(OH), or (RN)P(OH)₂ (wherein R represents the fluoroalkyl group); and
fluoroalkylphosphonic acid represented by the general formula: RPO(OH)₂ (wherein R represents the fluoroalkyl group).

As the phosphoric acid derivatives containing fluorine, preferred are: ammonium hexafluorophosphate, methylammonium hexafluorophosphate, dimethylammonium hexafluorophosphate, trimethylammonium hexafluorophosphate, ethylammonium hexafluorophosphate, diethylammonium hexafluorophosphate, triethylammonium hexafluorophosphate, butylammonium hexafluorophosphate, dibutylammonium hexafluorophosphate, tetra-n-butylammoniumhexafluorophosphate, tetramethylammonium hexafluorophosphate, tetraethylammonium hexafluorophosphate, and tetrabutylammonium hexafluorophosphate; and more preferred are: ammonium hexafluorophosphate, tetraethylammonium hexafluorophosphate, and 1-butyl-3-methylimidazolium hexafluorophosphate.

Examples of the sulfonic acid derivatives containing fluorine include:
a copolymer of tetrafluoroethylene and perfluoro[2-(fluorosulfonylethoxy)propyl vinyl ether] (e.g., NAFION (registered trademark), copolymer having a structure represented by the following formula);

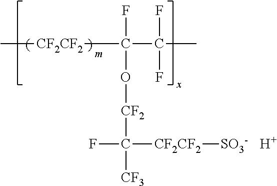

fluoroalkylsulfonic acids in which all or some of the hydrogen atoms of an alkyl group are substituted by a fluorine atom (the number of carbon atoms is, for example, 1 to 30) (e.g., nonacosadecafluorotetradecanesulfonic acid, heptacosadecafluorotridecanesulfonic acid, tricosadecafluoroundecanesulfonic acid, nonadecafluorononanesulfonic acid, pentadecafluoroheptanesulfonic acid, undecafluoropentanesulfonic acid, nonafluorobutanesulfonic acid, heptafluoropropanesulfonic acid, trifluoromethanesulfonic acid, and 2,2,2-trifluoroethanesulfonic acid);
esters of the fluoroalkylsulfonic acids (e.g., methyl esters, ethyl esters, and aryl esters (e.g., phenyl ester));
salts of the fluoroalkylsulfonic acids (general formula: A[RSO₃]; R represents the fluoroalkyl group) (sodium salts, potassium salts, ammonium salts, alkylammonium (e.g., methylammonium, dimethylammonium, trimethylammonium, ethylammonium, diethylammonium, and triethylammonium) salts);
amides of the fluoroalkylsulfonic acids (general formula: R—SO₂—NR¹R², R represents the fluoroalkyl group; and R¹ and R² each independently represent a hydrocarbon group having 1 to 10 carbon atoms (e.g., methyl group, ethyl group, phenyl group)), in which all or some of the hydrogen atoms may be substituted by a fluorine atom;
acid anhydrides of the fluoroalkylsulfonic acids (general formula: (R—SO₂)₂O; R represents the fluoroalkyl group); and
halides of the fluoroalkylsulfonic acids (general formula: (R—SO₂)X; R represents the fluoroalkyl group; and X represents fluorine, chlorine, bromine, or iodine).

As the sulfonic acid derivatives containing fluorine, preferred are: a copolymer of tetrafluoroethylene and perfluoro[2-(fluorosulfonylethoxy)propyl vinyl ether] (e.g., NAFION (registered trademark)), heptadecafluorooctanesulfonic acid, pentadecafluoroheptanesulfonic acid, undecafluoropentanesulfonic acid, heptafluoropropanesulfonic acid, trifluoromethanesulfonic acid, ammonium heptadecafluorooctanesulfonate, ammonium pentadecafluoroheptanesulfonate, ammonium tridecafluorohexanesulfonate, ammonium nonafluorobutanesulfonate, ammonium pentafluoroethanesulfonate, ammonium trifluoromethanesulfonate, trimethylammonium trifluoromethanesulfonate, triethylammonium trifluoromethanesulfonate, tetramethylammonium trifluoromethanesulfonate, tetraethylammonium trifluoromethanesulfonate, tetrabutylammonium trifluoromethanesulfonate, methyl trifluoromethanesulfonate, ethyl trifluoromethanesulfonate, nonafluoro-1-butanesulfonic acid, ferrous trifluoromethanesulfonate, and trifluoromethanesulfonic anhydrides;
more preferred are: trifluoromethanesulfonic acid, heptadecafluorooctanesulfonic acid, nonafluoro-1-butanesulfonic acid, tetrabutylammonium trifluoromethanesulfonate, ammonium heptadecafluorooctanesulfonate, and ferrous trifluoromethanesulfonate; and
further preferred are: compounds that has a skeleton with interface activity power, i.e., a hydrophobic site and a hydrophilic site in the molecule in view of causing stabilization in a reaction systems.

These may be used singly or in combination of two or more kinds.

In the case of using the compound (3) containing at least one element A selected from the group consisting of boron, phosphorus, and sulfur, the amount of the element A contained in the compound (3) used in the step (1) (i.e., the total number of atoms of the element A contained in the compound (3) used in the step (1)) is typically 0.01 to 3 mol, preferably 0.01 to 2 mol, further preferably 0.01 to 1 mol, based on 1 mol of metal atoms in the metal compound (1) used in the step (1).

When the element A is only boron, the amount thereof is typically 0.01 to 3 mol, preferably 0.01 to 2 mol, further preferably 0.01 to 1 mol, based on the above-described criterion; when the element A is only phosphorus, the amount thereof is typically 0.01 to 3 mol, preferably 0.01 to 2 mol, further preferably 0.01 to 1 mol, based on the above-described criterion; and when the element A is only sulfur, the amount thereof is typically 0.01 to 3 mol, preferably 0.01 to 2 mol, further preferably 0.01 to 1 mol, based on the above-described criterion.

Further, the amount of fluorine contained in the compound (3) used in the step (1) (i.e., the total number of fluorine atoms contained in the compound (3) used in a step (1)) is typically 0.01 to 5 mol, preferably 0.02 to 4 mol, further preferably 0.03 to 3 mol, based on 1 mol of metal atoms in the metal compound (1) used in the step (1).

The above-described amount of the compound (3) is an amount in a case in which a raw material other than the compound (3) used in the step (1) contains neither element A nor fluorine. It is preferable to appropriately reduce the amount of the compound (3) used in the step (1) when the raw material other than the compound (3) contains the element A or fluorine.

<Solvent>

Examples of the solvent include water, alcohols, and acids. As the alcohols, ethanol, methanol, butanol, propanol, and ethoxyethanol are preferred; and ethanol and methanol are further preferred. As the acids, acetic acid, nitric acid (aqueous solution), hydrochloric acid, an aqueous phosphoric acid solution, and an aqueous citric acid solution are preferred; and acetic acid and nitric acid are further preferred. These may be used singly or in combination of two or more kinds.

When the metal compound (1) is a metal halide, the solvent is preferably methanol.

The solvent may also be used so that the amount thereof is, for example, 50 to 95 mass % in 100 mass % of a solution for producing a precursor.

<Precipitation Suppressant>

When the metal compound (1) contains halogen atoms, in general, these compounds are easily hydrolyzed by water to cause precipitates of hydroxides, acid chlorides, and the like. Thus, when the metal compound (1) contains halogen atoms, it is preferable that a strong acid is added in such a manner that the amount of the strong acid in a solution (solution for producing a precursor) becomes 1 mass % or more. For example, when the acid is hydrochloric acid, by adding the acid in such a manner that the concentration of hydrogen chloride in the solution (solution for producing a precursor) becomes 5 mass % or more, more preferably 10 mass % or more, a clear solution for producing a precursor can be obtained while preventing the occurrence of the precipitation of a hydroxide, an acid chloride, or the like derived from the metal compound (1).

Further, in the case where the metal compound (1) contains a halogen atom, a solution for producing a precursor may be obtained by using an alcohol alone as the solvent and by adding no acid.

In the case where the metal compound (1) is a metal complex with the solvent being water alone or a combination of water and another compound, it is also preferable to use the precipitation suppressant for suppressing the occurrence of the precipitation of a hydroxide or an acid chloride. In this case, the precipitation suppressant is preferably a compound having a diketone structure; more preferably diacetyl, acetylacetone, 2,5-hexanedione, and dimedone; further preferably acetylacetone and 2,5-hexanedione.

The precipitation suppressant is added so that the amount of the precipitation suppressant becomes preferably 1 to 70 mass %, more preferably 2 to 50 mass %, further preferably 15 to 40 mass %, in 100 mass % of a metal compound solution (solution that contains the metal compound (1) but contains neither the nitrogen-containing organic compound (2) nor the compound (3)).

The precipitation suppressant is added preferably so that the amount of the precipitation suppressant becomes preferably 0.1 to 40 mass %, more preferably 0.5 to 20 mass %, further preferably 2 to 10 mass % in 100 mass % of the solution for producing a precursor.

The precipitation suppressant may be added in any stage of the step (1).

In the step (1), preferably, a solution that contains the metal compound (1) and the precipitation suppressant is prepared, and this solution is then mixed with the nitrogen-containing organic compound (2) and optionally the compound (3) to obtain a solution for producing a precursor. By performing the step (1) in this way, the occurrence of the precipitation can be more surely prevented.

(Step (2))

In the step (2), the solvent is removed from the solution for producing a precursor obtained in the step (1).

The solvent removal may be performed in air, or may be performed under an atmosphere of an inert gas (for example, nitrogen, argon, and helium). As the inert gas, from the viewpoint of a cost, nitrogen and argon are preferred; and nitrogen is more preferred.

The temperature in the solvent removal may be ordinary temperature when the vapor pressure of the solvent is large, but from the viewpoint of mass production of a catalyst precursor, temperature is preferably 30° C. or more, more preferably 40° C. or more, further preferably 50° C. or more; and from the viewpoint of preventing the decomposition of the substance that is presumed to be a metal complex, such as a chelate, contained in the solution obtained in the step (1), the temperature is preferably 350° C. or less, more preferably 150° C. or less, further preferably 110° C. or less.

The solvent removal may be performed under atmospheric pressure when the vapor pressure of the solvent is high, but may be performed under reduced pressure (e.g., 0.1 Pa to 0.1 MPa) in order to remove the solvent within a shorter period of time. For the solvent removal under reduced pressure, for example, an evaporator may be used.

The solvent removal may be performed with the mixture obtained in the step (1) being allowed to stand still; however, in order to obtain a more homogenous solid residue, preferred is the solvent removal with the mixture being rotated.

When the mass of a container holding the mixture is large, it is preferable that the solution is rotated using a stirring rod, a stirring blade, a stirring bar, or the like.

When the solvent removal is performed while regulating the vacuum degree of a container holding the mixture, in which case the drying is performed in a sealable container, it is preferable that the solvent removal is performed while the whole container is rotated: for example, it is preferable that the solvent removal is performed using e.g., a rotary evaporator.

Depending on solvent-removal methods or properties of the metal compound (1), the nitrogen-containing organic compound (2), or the compound (3), the solid residue obtained in the step (2) may have a non-uniform composition or be at a non-uniform agglomeration state. In this case, the solid residue may be subjected to mixing and crushing to obtain more uniform and finer powders to be used in the step (3), whereby a catalyst precursor can be obtained which has more uniform particle diameter.

For the mixing and crushing of the solid residue, for example, a roll-rotating mill, a ball mill, a small-diameter ball mill (bead mill), a medium-stirring mill, an air flow crusher, a mortar, an automatic kneading mortar, a crushing tank, or a jet mill is employable; when the solid residue has been provided in a small amount, a mortar, an automatic kneading mortar, or a batch-type ball mill is preferably used; and when the solid residue has been provided in a large amount and is to be subjected to continuous mixing or crushing treatment, a jet mill is preferably used.

(Step (3))

In the step (3), the solid residue obtained in the step (2) is heat-treated to obtain a catalyst precursor.

The temperature in this heat treatment is preferably 500 to 1100° C., more preferably 600 to 1050° C., further preferably 700 to 950° C.

Examples of methods of the heat treatment method include a standing method, a stirring method, a dropping method, and a powder capturing method.

The standing method is a method in which the solid residue obtained in the step (2) is placed in a stationary electric furnace or the like and is heated. During the heating, the solid residue that has been weighed may also be put in a ceramic container such as an alumina boat or a quartz boat. The standing method is preferable in view of being able to heat a large amount of the solid residue.

The stirring method is a method in which the solid residue is put in an electric furnace such as a rotary kiln and is heated while being stirred. The stirring method is preferable in view of being able to heat a large amount of the solid residue and in view of being able to prevent the aggregation and growth of the resultant catalyst precursor particles. Furthermore, the stirring method is preferable in view of being able to continuously produce the catalyst precursor by sloping a furnace.

The dropping method is a method in which an induction furnace is heated to a predetermined heating temperature while flowing an atmosphere gas through the furnace, a thermal equilibrium is maintained at the temperature, and thereafter the solid residue is dropped and heated in a crucible which is a heating zone in the furnace. The dropping method is preferable in view of being able to minimizing the aggregation and growth of the resultant catalyst precursor particles.

The powder capturing method is a method by which the solid residue is caused to suspend as particles in an inert gas atmosphere containing a trace amount of an oxygen gas and the solid residue is captured and heated in a vertical tubular furnace kept at a predetermined heating temperature.

When the heat treatment is performed by the standing method, a temperature-raising rate, which is not particularly limited, is preferably around 1° C./min to 100° C./min, more preferably 5° C./rain to 50° C./min. Further, the heating time is preferably 0.1 to 10 hours, more preferably 0.5 to 5 hours, further preferably 0.5 to 3 hours. When the heating by the standing method is performed in a tubular furnace, the heating time of the solid residue is 0.1 to 10 hours, preferably 0.5 hour to 5 hours. The heating time in this range leads to the tendency of the formation of uniform catalyst precursor particles.

Under the stirring method, the heating time of the solid residue is usually 10 minutes to 5 hours, preferably 30 minutes to 2 hours. Under this method, when the solid residue is continuously heated, for example, by sloping the furnace, the heating time is defined as a mean residence time calculated from the sample flowing amount in a steady furnace.

Under the dropping method, the heating time of the solid residue is usually 0.5 to 10 minutes, preferably 0.5 to 3 minutes. The heating time within this range leads to the tendency of the formation of uniform catalyst precursor particles.

Under the powder capturing method, the heating time of the solid residue is 0.2 second to 1 minute, preferably 0.2 to 10 seconds. The heating time within this range leads to the tendency of the formation of uniform catalyst precursor particles.

When the heat treatment is performed under the standing method, a heating furnace employing LNG (liquefied natural gas), LPG (liquefied petroleum gas), light oil, heavy oil, electricity, or the like as a heat source may be used as a heat treatment apparatus. In this case, since the atmosphere in heat treatment of the solid residue is important in the present invention, a preferable apparatus is not a heating apparatus that holds fuel flame within the furnace and thereby provides heating from the inside of the furnace, but a heating apparatus that provides heating from the outside of the furnace.

When a heating furnace is used which provides the solid residue in an amount of 50 kg or more per one batch, from the viewpoint of a cost, a heating furnace employing LNG or LPG as a heat source is preferable.

When a catalyst precursor for obtaining an electrode catalyst having particularly high catalytic activity is desired, it is preferable to use an electric furnace employing electricity as a heat source, which allows for the strict controlling of temperature.

Exemplary shapes of the furnace include a tubular furnace, a top-loading furnace, a tunnel furnace, a box furnace, a sample table elevating-type furnace (elevator furnace), a car-bottom furnace, and the like; of these, preferred are a tubular furnace, a top-loading furnace, a box furnace, and a sample table elevating-type furnace, which allow for the particular strict controlling of atmosphere; and preferred are a tubular furnace and a box furnace.

When the stirring method is adopted, the above heat source is also employable; however, especially when the solid residue is continuously heat-treated by the stirring method using an inclined rotary kiln, it is likely that the equipment size becomes larger and a large amount of energy is needed; and thus it is preferable to use a heat source derived from fuels such as LPG.

The atmosphere in performing the heat treatment is preferably atmosphere containing an inert gas as amain component, which allows the electrode catalyst obtained after further subjected to the contact step described below to have increased activity. Among the inert gases, in view of relative inexpensiveness and easy availability, nitrogen, argon, and helium are preferred; and nitrogen and argon are further preferred. These inert gases may be used singly or in combination of two or more kinds. Although these gases are commonly recognized as being inert, there is a possibility that in the heat treatment of the step (3), these inert gases, i.e., nitrogen, argon, helium, and the like are reacted with the solid residue.

The presence of a reactive gas in the atmosphere in performing the heat treatment may allow the electrode catalyst obtained after further subjected to the contact step described below to have higher catalytic performance. For example, when the heat treatment is performed under the atmosphere of a nitrogen gas; an argon gas; a mixed gas of a nitrogen gas and an argon gas; or a mixed gas of one or more gases selected from a nitrogen gas and an argon gas and one or more gases selected from a hydrogen gas, an ammonia gas, and an oxygen gas, an electrode catalyst having high catalytic performance tends to be obtained after further subjected to the contact step described below.

When the atmosphere in performing the heat treatment contains a hydrogen gas, the concentration of the hydrogen gas is, for example, 100% by volume or less, preferably 0.01 to 10% by volume, more preferably 1 to 5% by volume.

When the atmosphere in performing the heat treatment contains an oxygen gas, the concentration of the oxygen gas is, for example, 0.01 to 10% by volume, preferably 0.01 to 5% by volume.

A pressure in the heat treatment is not particularly limited, and the heat treatment may also be carried out under atmospheric pressure in consideration of production stability, a cost, and the like.

After the heat treatment, a heat-treated product may also be crushed. Performing the crushing may improve the processability in using the electrode catalyst obtained after further subjected to the contact step described below to produce an electrode, and the properties of the resultant electrode. For the crushing, for example, a roll-rotating mill, a ball mill, a small-diameter ball mill (bead mill), a medium-stirring mill, an air flow crusher, a mortar, an automatic kneading mortar, a crushing tank, or a jet mill may be used. When the catalyst precursor has been provided in a small amount, a mortar, an automatic kneading mortar, or a batch-type ball mill is preferred; and when the heat-treated product is to be continuously treated in a large amount, a jet mill or a continuous-type ball mill is preferred, and among the continuous-type ball mills, a bead mill is further preferred.

Examples of the catalyst precursor include: in addition to a catalyst precursor produced by a method other than the above-mentioned method (A) for producing a catalyst precursor,
a catalyst precursor produced by a production method using no solvent in the method (A) for producing a catalyst precursor (i.e., a production method comprising a step of heat-treating a mixture containing at least the metal compound (1) and the nitrogen-containing organic compound (2) and containing no solvent (preferably at a temperature of 500 to 1100° C.) to obtain a catalyst precursor, wherein a portion or the entirety of the metal compound (1) contains copper, and among the components contained in the mixture, at least one component has an oxygen atom); and
a catalyst precursor produced by a production method comprising a step of heat-treating a metal carbonitride containing copper, and optionally iron or the metal element (M3) as metal elements in an inert gas containing oxygen (hereinafter also referred to as a “method (B) for producing a catalyst precursor”).

Examples of methods for producing the metal carbonitride in the method (B) for producing a catalyst precursor include:
a method (I) of producing a metal carbonitride by heat-treating a mixture containing a compound containing copper, and optionally a compound containing iron or a compound containing the metal M3 (where carbon and nitrogen are contained in any of these compounds and a heat-treatment atmosphere);
a method (II) of producing a metal carbonitride by heat-treating a mixture of carbon and a copper oxide, and optionally an iron oxide or an oxide of the metal element (M3) in a nitrogen atmosphere or an inert gas containing nitrogen; and the like.

As the detailed conditions of the step of heat-treating the metal carbonitride in an inert gas containing oxygen and the step of producing the metal carbonitride in the methods (I) and (II), for example, the conditions of similar steps in a method for producing a catalyst described in Patent Literature 1 (WO 2009/91043) can be applied. For example, temperature in the heat treatment of the metal carbonitride is typically 400 to 1400° C., preferably 600 to 1200° C., and temperature in the production of the metal carbonitride is typically 600 to 1800° C., preferably 800 to 1600° C.

A fuel cell electrode catalyst known in the art containing each atom of a metal element, carbon, nitrogen, and oxygen and containing copper as the metal element may also be used as the catalyst precursor.

Preferably, the catalyst precursor is crushed and then subjected to the next contact step.

<Contact Step>

In the contact step, the catalyst precursor and an acid solution are brought into contact with each other, whereby a fuel cell electrode catalyst is obtained.

Examples of the acid include hydrogen chloride, sulfuric acid, citric acid, acetic acid, fluorinated acid, phosphoric acid, and nitric acid; and hydrogen chloride, sulfuric acid, citric acid, acetic acid, nitric acid, and phosphoric acid are preferred. These may be used singly or in combination of two or more kinds.

As a solvent for the acid solution, hydrophilic solvents are preferred; compounds having hydroxyl group, compounds having an ether bond, and water are more preferred; alcohols such as methanol, ethanol, propanol, isopropanol, and butanol, cyclic ethers such as THF (tetrahydrofuran), and water are further preferred; and water is particularly preferred. These may be used singly or in combination of two or more kinds.

The concentration of the acid in the acid solution is preferably 0.01 to 15 N, more preferably 0.5 to 13 N, further preferably 1 to 13 N, at 25° C. The concentration of the acid in the above-described range is preferred in view of easily leading to homogeneous dissolution of copper in the catalyst precursor.

Further, temperature in the contact step (hereinafter also referred to as “contact temperature”) is preferably 15 to 100° C., more preferably 20 to 80° C., further preferably 25 to 70° C. The contact temperature in the above-described range is preferred in view of leading to rapid dissolution of copper in the catalyst precursor to inhibit evaporation of the acid solution.

Time in the contact step (hereinafter also referred to as “contact time”) is preferably 0.1 to 500 hours, more preferably 5 to 300 hours, further preferably 6 to 150 hours. The contact time in the above-described range is preferred in view of allowing dissolution of copper in the catalyst precursor to homogeneously proceed.

In the contact step, for example, the catalyst precursor and the acid solution are put in a container, whereby both are brought into contact with each other. In this case, it is preferable to perform stirring. A rate between the catalyst precursor and the acid solution also depends on the types thereof and the like, and as a guide, the acid solution is preferably 10 to 50000 mL, more preferably 30 to 10000 mL, based on 1 g of the catalyst precursor.

The catalyst precursor and the acid solution are brought into contact with each other, whereby a portion of metal elements in the catalyst precursor is eluted. For example, preferably 50% or more, more preferably 90% or more, of copper contained in the catalyst precursor prior to the elution is eluted. When the catalyst precursor contains a metal element other than copper, all the copper may be eluted if an element other than the copper remains in the catalyst precursor. The amount of the eluted metal elements tends to be increased by, for example, increasing the concentration of the acid, increasing the contact temperature, prolonging the contact time, or the like.

The contact step is completed by collecting a solid obtained through the contact step (hereinafter also referred to as a “contact-treated product”). Examples of means for collecting the contact-treated product include known techniques such as suction filtration and centrifugation.

<Cleaning Step>

The production method of the present invention preferably comprises a cleaning step of cleaning the contact-treated product after the contact step.

The cleaning step allows an eluted metal component which becomes the factor of deterioration of an electrolyte membrane to be able to be still more removed from the contact-treated product after the contact step.

The cleaning step is performed, for example, by putting cleaning liquid and the contact-treated product in a container, whereby both are brought into contact with each other. In this case, it is preferable to perform stirring.

Examples of the cleaning liquid include water and the like.

<Drying Step>

The production method of the present invention preferably comprises a drying step of drying the contact-treated product after the contact step, more preferably comprises the drying step in the cleaning step.

Aspects of the drying in the drying step include vacuum drying (reduced-pressure drying), heat drying, and the like.

The drying step is preferably performed at a temperature of 100° C. or less from the viewpoint of preventing agglomeration of the contact-treated product.

[Fuel Cell Electrode Catalyst]

The fuel cell electrode catalyst according to the present invention is a catalyst produced by the production method according to the present invention.

The fuel cell electrode catalyst is preferably a powder for enhancing catalytic performance.

The fuel cell electrode catalyst can be used as a catalyst alternative to a platinum catalyst.

According to the method for producing a fuel cell electrode catalyst of the present invention, a fuel cell electrode catalyst having a large specific surface area is produced, and the specific surface area of the catalyst of the present invention as calculated by BET method is preferably 50 m²/g or more, more preferably 100 to 1200 m²/g, further preferably 200 to 900 m²/g. This specific surface area can be increased, for example, with increasing the amount of the metal elements in the catalyst precursor that is removed in the contact step.

[Uses]

(Fuel Cell Electrode Catalyst Layer)

The fuel cell electrode catalyst layer according to the present invention comprises the fuel cell electrode catalyst.

The fuel cell electrode catalyst layer preferably further comprises an electron conductive powder. When the fuel cell electrode catalyst layer comprising the catalyst further comprises the electron conductive powder, the reduction current can be more increased. It is considered that the electron conductive powder increases the reduction current because of allowing the catalyst to have an electrical bond for inducing electrochemical reaction.

The electron conductive particles are usually used as a carrier of the catalyst.

The fuel cell electrode catalyst layer preferably further comprises a polymer electrolyte. The polymer electrolytes are not particularly limited as long as being those commonly used in fuel cell electrode catalyst layers.

The fuel cell electrode catalyst layer may be used as an anode catalyst layer or a cathode catalyst layer. The fuel cell electrode catalyst layer comprises the catalyst that has high oxygen reducing ability and is resistant to corrosion in acidic electrolytes even at high potential, is therefore useful as a catalyst layer provided in a cathode of a fuel cell (as a cathode catalyst layer), and is particularly useful as a catalyst layer provided in a cathode of a membrane electrode assembly in a polymer electrolyte fuel cell.

(Electrode)

The electrode according to the present invention comprises the fuel cell electrode catalyst layer and a porous support layer.

The electrode may be used as any electrode of a cathode or an anode. The electrode has excellent durability and high catalytic performance, and therefore using the electrode as a cathode leads to more effect.

(Membrane Electrode Assembly)

The membrane electrode assembly of the present invention (hereinafter also referred to as “MEA”) comprises a cathode, an anode, and an electrolyte membrane interposed between the cathode and the anode, wherein the cathode and/or the anode are the electrodes according to the present invention. The electrode according to the present invention is preferably used as the cathode; and in this case, a fuel cell electrode known in the art, for example, an electrode containing a platinum-based catalyst may be used as the anode.

As the electrolyte membranes, perfluorosulfonic acid-based electrolyte membranes or hydrocarbon electrolyte membranes are generally used, and there may also be used membranes in which polymer microporous membranes are impregnated with liquid electrolyte; membranes in which porous bodies are filled with polymer electrolyte; or the like.

According to the present invention, the cell voltage of the membrane electrode assembly (“cell voltage 20 hours after starting operation” (catalytic performance) in “Evaluation of Catalytic Performance and Durability of Membrane Electrode Assembly” as described below) can be allowed to be higher than the cell voltage of a membrane electrode assembly that is produced by changing the catalyst to the catalyst precursor used in the production of the catalyst and is measured in a similar manner by preferably 50 mV or more, more preferably 80 mV or more, further preferably 100 mV or more.

Further, a voltage drop per unit time in a case in which the continuous operation of a fuel cell is started and thereafter a voltage fluctuation thereof is substantially constant in a state in which the voltage fluctuation is low (“inclination of voltage drop” (catalyst durability) in “Evaluation of Catalytic Performance and Durability of Membrane Electrode Assembly” as described below) can be allowed to be preferably 6 mV/hour or less, more preferably 3 mV/hour or less, further preferably 1.5 mV/hour or less.

(Fuel Cell)

The fuel cell according to the present invention comprises the membrane electrode assembly.

The electrode reaction in fuel cells takes place at a so-called three-phase interface (electrolyte-electrode catalyst-reactant gas). The fuel cells are classified according to the electrolytes used, into several types such as molten carbonate type (MCFC), phosphoric acid type (PAFC), solid oxide type (SOFC), polymer electrolyte type (PEFC), and the like. The fuel cell according to the present invention is preferably a polymer electrolyte fuel cell.

### EXAMPLES

The present invention will be specifically described below based on examples and the like but the present invention is not limited to these examples.

Various measurements were performed by the following methods.

1. Elemental Analysis;

<Metals>

About 0.1 g of a sample was weighed in a quartz beaker to completely decompose the sample by heating, using sulfuric acid, nitric acid, and fluorinated acid. After cooling, this solution was quantitatively determine to 100 ml, was further appropriately diluted, and was quantitated using ICP-OES (VISTA-PRO manufactured by SII) or ICP-MS (HP7500 manufactured by Agilent).

<Carbon, Sulfur>

About 0.01 g of a sample was weighed and measured with a carbon/sulfur analyzer (EMIA-920V manufactured by HORIBA, Ltd.).

<Nitrogen, Oxygen>

About 0.01 g of a sample was weighed, was sealed in a Ni capsule, and was measured with an oxygen/nitrogen analyzer (TC600 manufactured by LECO).

<Fluorine>

Several mg of a sample was decomposed by combustion while flowing water vapor under oxygen air stream. A generated gas was made to be absorbed by 10 mM Na₂CO₃ (containing hydrogen peroxide; standard for correction Br—: 5 ppm) to measure the amount of fluorine by ion chromatography.

Combustion Decomposition Conditions:

Sample combustion apparatus: AQF-100 (manufactured by Mitsubishi Chemical Analytech Co., Ltd.)

Combustion tube temperature: 950° C. (temperature-raising decomposition by moving sample boat)

Ion chromatography measurement conditions
Measuring apparatus: DIONEX DX-500
Eluent: 1.8 mM Na₂CO₃+1.7 mM NaHCO₃
Column (temperature): ShodexSI-90 (room temperature)
Flow rate: 1.0 ml/min
Injection amount: 25 μl
Detector: Electric conductivity detector
Suppressor: DIONEX ASRS-300

2. BET Specific Surface Area Measurement;

A BET specific surface area was measured using Micromeritics Gemini 2360 manufactured by Shimadzu Corporation. The pretreatment time and the pretreatment temperature were set at 30 minutes and 200° C., respectively.

3. Evaluation of Membrane Electrode Assembly;

(1) Production of Anode

(i) Preparation of Anode Ink

Into 50 ml of pure water, 0.6 g of platinum-supported carbon (TEC10E60E, manufactured by TANAKA KIKINZOKU KOGYO K.K.) and 5 g of an aqueous solution containing 0.25 g of a proton conductive material (NAFION (registered trademark)) (5% NAFION (registered trademark) aqueous solution, manufactured by Wako Pure Chemical Industries, Ltd.) were put, and the resultant solution was mixed with an ultrasonic wave dispersion machine (UT-106H, manufactured by Sharp Manufacturing Systems Corporation) for 1 hour, whereby an anode ink was prepared.

(ii) Production of Electrode Having Anode Catalyst Layer

A gas diffusion layer (carbon paper (TGP-H-060, manufactured by Toray Industries, Inc.) was immersed in acetone for 30 seconds to be degreased, thereafter dried, and then immersed in an aqueous 10% polytetrafluoroethylene (hereinafter also referred to as “PTFE”) solution for 30 seconds.

The immersed product was dried at room temperature and was then heated at 350° C. for 1 hour, to thereby obtain a water-repellent gas diffusion layer having PTFE dispersed in the carbon paper (hereinafter also referred to as “GDL”).

Then, the GDL was formed into the size of 5 cm×5 cm, and the surface thereof was coated with the anode ink using an automatic spray-coating apparatus (manufactured by San-Ei Tech Ltd.) at 80° C. The spray-coating was repeated to thereby produce an electrode having an anode catalyst layer in which the amount of platinum (Pt) per unit area was 1 mg/cm² (hereinafter also simply referred to as an “anode”).

(2) Production of Cathode

(i) Preparation of Cathode Ink

For each catalyst obtained in examples and comparative examples, 0.2 g of the catalyst, 0.05 g of carbon black (KETJENBLACK EC300J, Lion Corporation) as an electronically conductive material, and 0.75 g of an aqueous proton conductive material solution (aqueous solution containing 0.14 g of NAFION (registered trademark), Wako Pure Chemical Industries, Ltd.) were mixed in a planetary centrifugal mixer (THINKY MIXER, THINKY CORPORATION) for 15 minutes to thereby prepare a cathode ink.

(ii) Production of Electrode Having Cathode Catalyst Layer

A gas diffusion layer (carbon paper (TGP-H-060, Toray Industries, Inc.)) was immersed in acetone for 30 seconds and degreased, thereafter dried, and then immersed in an aqueous 10% polytetrafluoroethylene (PTFE) dispersion (dispersion obtained by 6-fold diluting an aqueous 60% PTFE dispersion (manufactured by Aldrich) with water) for 30 seconds.

The immersed product was dried at room temperature, and was thereafter heated at 350° C. for 1 hour, to thereby obtain a water-repellent gas diffusion layer having PTFE dispersed in the carbon paper (hereinafter also referred to as “GDL”).

Then, the GDL was formed into the size of 5 cm×5 cm, and the surface thereof was coated with the cathode ink by bar coater application method at 80° C. to produce an electrode having a cathode catalyst layer on the GDL surface (hereinafter also simply referred to as “cathode”).

(3) Production of Fuel Cell Membrane Electrode Assembly

NAFION (registered trademark) membrane (NR-212, manufactured by DuPont) as an electrolyte membrane was held by the cathode produced in (2) and the anode produced in (1); and in such a manner that the cathode catalyst layer and the anode catalyst layer would adhere to the electrolyte membrane, these were thermocompression bonded using a hot pressing machine at a temperature of 140° C. and at a pressure of 3 MPa for 6 minutes, to thereby produce a fuel cell membrane electrode assembly in which the electrolyte membrane was placed between the cathode and the anode (hereinafter also referred to as “MEA”).

(4) Production of Single Cell

The MEA was sequentially held by two sealing materials (gaskets), two separators each having a gas flow passage, two collectors and two rubber heaters, fixed with a bolt, and secured so that a surface pressure would be a predetermined value (4 N), to thereby produce a single cell (cell area: 5 cm²) of a polymer electrolyte fuel cell.

(5) Evaluation of Catalytic Performance and Durability of Membrane Electrode Assembly

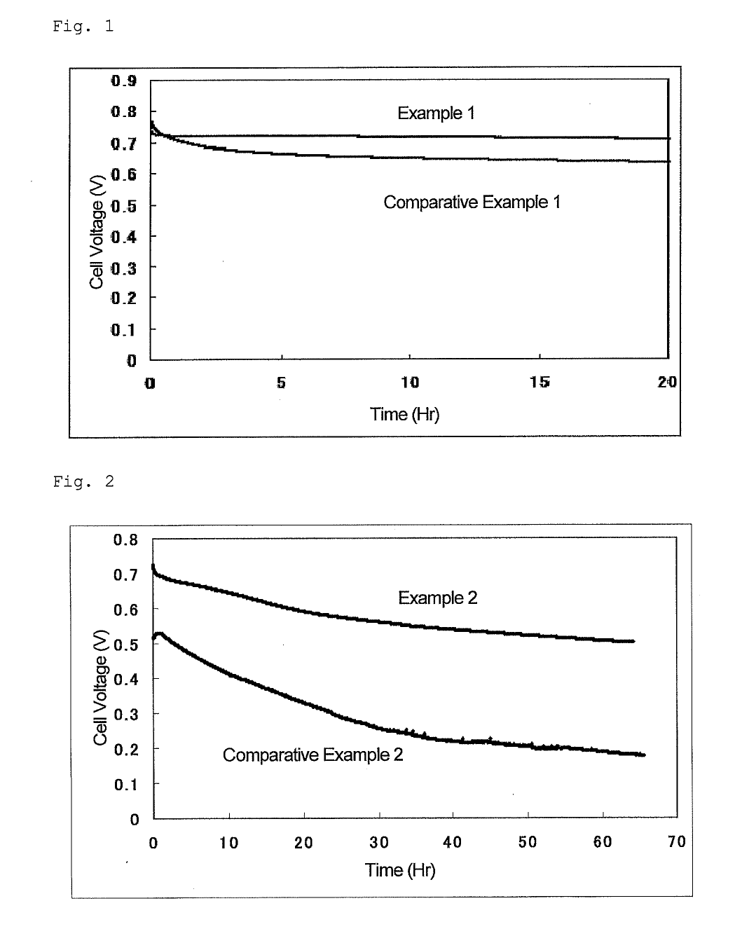

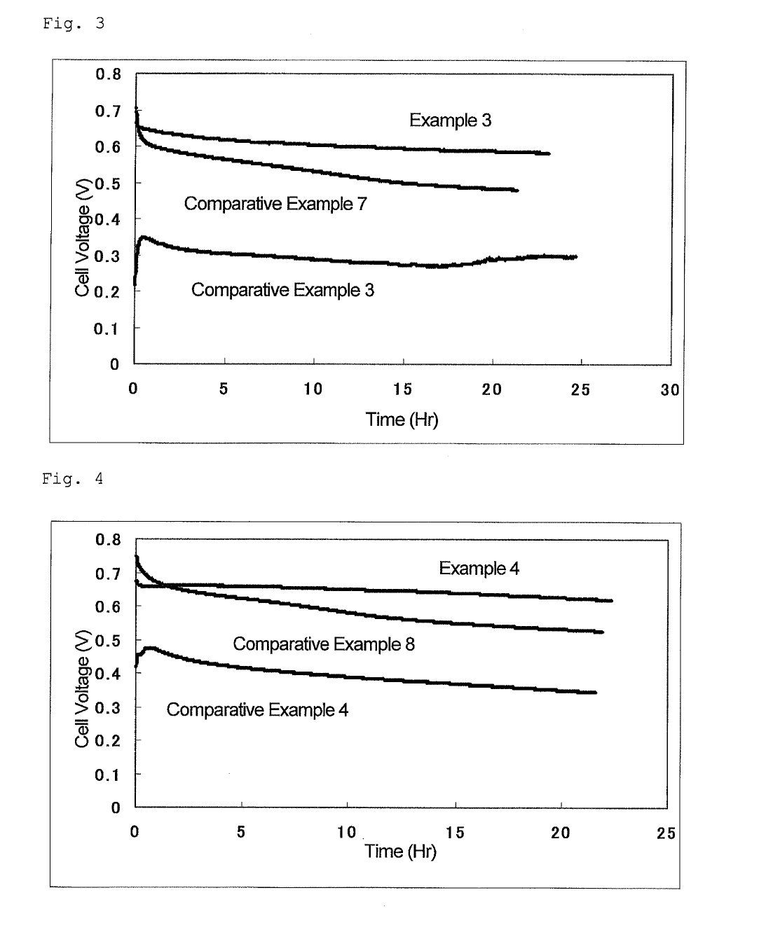

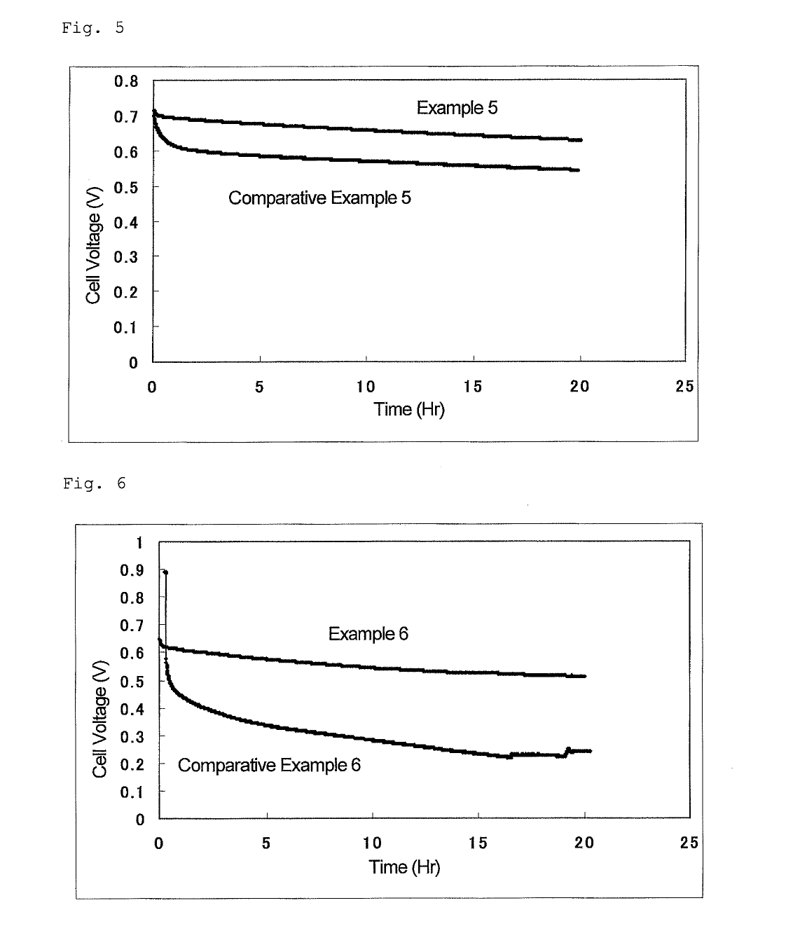

The temperature of the single cell, the temperature of an anode humidifier, and the temperature of a cathode humidifier were regulated to be 80° C., 80° C. and 80° C., respectively. To the anode side, hydrogen was supplied as a fuel at a flow rate of 0.1 L/min, and to the cathode side, oxygen was supplied as an oxidizing agent at a flow rate of 0.1 L/min. While applying a back pressure of 300 kPa to both sides, the variation of a cell voltage with time in the case of applying a current source load of 0.1 A/cm² to the single cell was measured. The variation of the voltage with time was plotted from the cell voltage data acquired every 30 seconds to make a curve of the variation of the voltage with time (FIGS. 1 to 6). In addition, a stage in which a rapid voltage fluctuation temporally occurs after staring continuous operation (stage a), a transition stage in which the voltage fluctuation is rapidly reduced after the stage a (stage b), and a stage in which the voltage fluctuation is substantially constant and low after the stage b (stage c) were grasped based on the curve of the variation of the voltage with time. In many cases, shift to the stage c is achieved around 5 hours after starting the operation.

In addition, a cell voltage was measured 20 hours after starting the operation after the shift to the stage c, and a higher value thereof was evaluated as higher catalytic performance.

Further, the plot of the cell voltage in a portion with the comparatively low variation of the cell voltage with time in a portion after the shift to the stage c (between 5 hours and 20 hours after starting the continuous operation) was approximated to a straight line by least square method, and the lower absolute value of the inclination of the obtained approximation straight line (i.e., voltage drop per unit time; also referred to as “inclination of voltage drop”) was evaluated as higher catalyst durability.

If the shift to the stage c is not achieved 5 hours after starting the operation, the measurement time may be sequentially postponed until the shift to the stage c, and the measurement may be performed. In this case, comparison of data measured at the same time after starting the operation is preferably performed as a relative evaluation between respective membrane electrode assemblies.

### Comparative Example 1

In a beaker, 50 ml of methanol was put; and while stirring this, 2.75 g (20.45 mmol) of copper dichloride, 12.5 ml of a 5% NAFION (registered trademark) solution (DE521, DuPont), and 355 mg (2.05 mmol) of iron(II) acetate were added sequentially. To the resultant solution, 7.61 g (60.8 mmol) of pyrazinecarboxylic acid was added little by little, followed by stirring the mixture for 3 hours to obtain a mixture (1). During the stirring, a precipitate was precipitated with the passage of time.

The mixture (1) was stirred with a rotary evaporator in a nitrogen atmosphere under reduced pressure with the temperature of a hot stirrer set at about 100° C., and thereby the solvent was slowly evaporated, the resultant solid residue was further heated at 300° C. for 1 hour under nitrogen gas stream, and the resultant was left standing to cool to room temperature and crushed with an automatic mortar for 30 minutes to obtain 3.47 g of a powder (1) for burning.

In a rotary kiln furnace, 1.80 g of the powder (1) for burning was heated to 950° C. at a temperature-raising rate of 10° C./min under the flowing at a rate of 20 mL/min of a nitrogen gas containing 4% by volume of a hydrogen gas (i.e., mixed gas of hydrogen gas: nitrogen gas=4% by volume: 96% by volume), was burnt at 950° C. for 0.5 hour, and was subjected to natural cooling to thereby obtain 703 mg of a powdery catalyst precursor (1) (hereinafter also referred to as a “catalyst (c1)”).

Further, a single cell was produced by the above-mentioned procedure using the catalyst (c1) and was evaluated. In the formed cathode layer, the total mass (mass per unit area) of the catalyst (c1) and carbon black was 2.5 mg/cm², and the mass (mass per unit area) of the catalyst (c1) was 2.27 mg/cm².

The evaluation results of the catalyst (c1) are listed in Table 1.

### Example 1

1. Preparation of Fuel Cell Electrode Catalyst;

A catalyst precursor (1) was produced by the same method as in Comparative Example 1 except that the amount of each raw material was quadrupled.

In a conical flask in which a stirring bar was put, 2800 mg of the catalyst precursor (1) and 100 ml of concentrated hydrochloric acid (12 N) were stirred for 6 hours at room temperature (25° C.); and the resultant was then filtrated using a two-ply filter (KIRIYAMA-ROHTO FILTER No. 5B, Kiriyama Glass Co.). An operation in which the residue was washed with distilled water and was filtrated was repeated until the filtrate became approximately neutral (pH about 6), and the residue was thereafter left standing at 80° C. for 8 hours in a drying machine to remove water, whereby 742 mg of a catalyst (1) was obtained.

Further, a single cell was produced by the above-mentioned procedure using the catalyst (1) and was evaluated. In the formed cathode layer, the total mass (mass per unit area) of the catalyst (1) and carbon black was 2.5 mg/cm², and the mass (mass per unit area) of the catalyst (1) was 2.06 mg/cm².

The evaluation results of the catalyst (1) are listed in Table 1.

### Comparative Example 2

In a beaker, 200 ml of methanol was put; and while stirring this, 11.0 g (81.8 mmol) of copper dichloride, 50 ml of a 5% NAFION (registered trademark) solution (DE521, DuPont), and 1.42 mg (8.18 mmol) of iron(II) acetate were added sequentially. To the resultant solution, 30.5 g (0.25 mol) of pyrazinecarboxylic acid was added little by little, followed by stirring the mixture for 3 hours (during the stirring, a precipitate was precipitated with the passage of time) and by further adding little by little a solution prepared by dissolving 1.73 g (16.4 mmol) of sodium carbonate in 60 ml of distilled water to obtain a mixture (2).

The mixture (2) was stirred with a rotary evaporator in a nitrogen atmosphere under reduced pressure with the temperature of a hot stirrer set at about 100° C., and thereby the solvent was slowly evaporated, the resultant solid residue was further heated at 300° C. for 1 hour under nitrogen gas stream, and the resultant was left standing to cool to room temperature and crushed with an automatic mortar for 30 minutes to obtain 16.1 g of a powder (2) for burning.

In a rotary kiln furnace, 1.20 g of the powder (2) for burning was heated to 890° C. at a temperature-raising rate of 10° C./min under the flowing at a rate of 20 mL/min of a nitrogen gas containing 4% by volume of a hydrogen gas (i.e., mixed gas of hydrogen gas: nitrogen gas=4% by volume: 96% by volume), was burnt at 890° C. for 0.5 hour, and was subjected to natural cooling to thereby obtain 862 mg of a powdery catalyst precursor (2) (hereinafter also referred to as a “catalyst (c2)”).

Further, a single cell was produced by the above-mentioned procedure using the catalyst (c2) and was evaluated.

The evaluation results of the catalyst (c2) are listed in Table 1.

### Example 2

A catalyst precursor (2) was produced by the same method as in Comparative Example 2 except that the amount of each raw material was quadrupled.

The same operation as in Example 1 was carried out, except that the catalyst precursor (1) was changed to 2800 mg of the catalyst precursor (2), to produce 604 mg of a catalyst (2).

The evaluation results of the catalyst (2) are listed in Table 1.

### Comparative Example 3

The same operation as in Comparative Example 1 was carried out, except that 2.75 g of copper dichloride was changed to 2.56 g (13.5 mmol) of titanium tetrachloride and 0.907 g (6.75 mmol) of copper dichloride and that the amount of pyrazinecarboxylic acid was changed to 10.2 g (81.8 mmol), to obtain 439 mg of a powdery catalyst precursor (3) (hereinafter also referred to as a “catalyst (c3)”). The mass of a powder for burning obtained in this process was 4.87 g.

Further, a single cell was produced by the above-mentioned procedure using the catalyst (c3) and was evaluated.

The evaluation results of the catalyst (c3) are listed in Table 1.

### Example 3

A catalyst precursor (3) was produced by the same method as in Comparative Example 3 except that the amount of each raw material was quadrupled.

The same operation as in Example 1 was carried out, except that the catalyst precursor (1) was changed to 1479 mg of the catalyst precursor (3) and that the amount of concentrated hydrochloric acid was changed to 53 ml, to produce 418 mg of a catalyst (3).

The evaluation results of the catalyst (3) are listed in Table 1.

### Comparative Example 4

In a beaker, 1.30 g (13.0 mmol) of acetylacetone was put; while stirring this, 3.97 g (10.4 mmol) of zirconium tetrabutoxide and 8 ml of acetic acid were added to prepare a zirconium solution (4).

In a beaker, 70 ml of water, 60 ml of ethanol, and 70 ml of acetic acid were put; and while stirring them, 4.37 g (35.2 mmol) of pyrazinecarboxylic acid and 5 ml of a 5% NAFION (registered trademark) solution (DE521, DuPont) were added thereto, and 145 mg (0.835 mmol) of iron(II) acetate was added thereto little by little and dissolved over around 10 minutes. Then, with the temperature kept at room temperature and stirring, the zirconium solution (4) was dropwise added over 10 minutes to obtain a solution A.

In a beaker, 50 ml of methanol was put; and while stirring this, 2.75 g (20.4 mmol) of copper dichloride, 12.5 ml of a 5% NAFION (registered trademark) solution (DE521, DuPont), and 355 mg (2.05 mmol) of iron(II) acetate were added. While the resultant solution was stirred, 7.61 g (60.8 mmol) of pyrazinecarboxylic acid was added thereto little by little to obtain a solution B.

The solution B was dropwise added to the solution A, followed by stirring for 3 hours to obtain a mixture (4). During the stirring, a precipitate was precipitated with the passage of time.

The mixture (4) was heated and stirred with a rotary evaporator in a nitrogen atmosphere under reduced pressure with the temperature of a hot stirrer set at about 100° C., and thereby the solvent was slowly evaporated. The solvent was completely evaporated and the resultant solid residue was crushed with an automatic mortar for 30 minutes to obtain 5.34 g of a powder (4) for burning.

The same operation as in Comparative Example 1 was carried out, except that the powder (1) for burning was changed to the powder (4) for burning, to obtain 641 mg of a powdery catalyst precursor (4) (hereinafter also referred to as a “catalyst (c4)”).

Further, a single cell was produced by the above-mentioned procedure using the catalyst (c4) and was evaluated.

The evaluation results of the catalyst precursor (c4) are listed in Table 1.

### Example 4

A catalyst precursor (4) was produced by the same method as in Comparative Example 4 except that the amount of each raw material was doubled.

The same operation as in Example 1 was carried out, except that the catalyst precursor (1) was changed to 735 mg of the catalyst precursor (4) and that the amount of concentrated hydrochloric acid was changed to 26 ml, to produce 341 mg of a catalyst (4).

The evaluation results of the catalyst (4) are listed in Table 1.

### Comparative Example 5

In a beaker, 158 ml of acetic acid was put; and while stirring this, 4.64 g (17.6 mmol) of zinc acetylacetonate was added to prepare a zinc solution (5).

In a beaker, 70 ml of water, 60 ml of ethanol, and 70 ml of acetic acid were put; and while stirring them, 8.74 g (70.4 mmol) of pyrazinecarboxylic acid and 10 ml of a 5% NAFION (registered trademark) solution (DE521, DuPont) were added thereto and dissolved by ultrasonic irradiation using an ultrasonic washer. While stirring the resultant solution, 290 mg (1.67 mmol) of iron(II) acetate was added thereto little by little and dissolved over around 10 minutes. Then, with the temperature kept at room temperature and stirring, the zinc solution (5) was dropwise added over 10 minutes to obtain a solution A.

In a beaker, 25 ml of methanol was put; and while stirring this, 1.37 g (10.2 mmol) of copper dichloride, 6.25 ml of a 5% NAFION (registered trademark) solution (DE521, DuPont), and 178 mg (1.02 mmol) of iron(II) acetate were added. While the resultant solution was stirred, 3.81 g (30.4 mmol) of pyrazinecarboxylic acid was added thereto little by little to obtain a solution B.

The solution B was dropwise added to the solution A, followed by stirring for 3 hours to obtain a mixture (5). During the stirring, a precipitate was precipitated with the passage of time.

The mixture (5) was heated and stirred with a rotary evaporator in a nitrogen atmosphere under reduced pressure with the temperature of a hot stirrer set at about 100° C., and thereby the solvent was slowly evaporated. The solvent was completely evaporated and the resultant solid residue was crushed with an automatic mortar for 30 minutes to obtain 5.76 g of a powder (5) for burning.

The same operation as in Comparative Example 1 was carried out, except that the powder (1) for burning was changed to the powder (5) for burning, to obtain 444 mg of a powdery catalyst precursor (5) (hereinafter also referred to as a “catalyst (c5)”).

Further, a single cell was produced by the above-mentioned procedure using the catalyst (c5) and was evaluated.

The evaluation results of the catalyst (c5) are listed in Table 1.

### Example 5

A catalyst precursor (5) was produced by the same method as in Comparative Example 5 except that the amount of each raw material was tripled.

The same operation as in Example 1 was carried out, except that the catalyst precursor (1) was changed to 1100 mg of the catalyst precursor (5) and that the amount of concentrated hydrochloric acid was changed to 40 ml, to produce 611 mg of a catalyst (5).

The evaluation results of the catalyst (5) are listed in Table 1.

### Comparative Example 6

The same operation as in Comparative Example 1 was carried out, except that 2.75 g of copper dichloride was changed to 1.81 g (13.5 mmol) of copper dichloride and 2.42 g (6.75 mmol) of tantalum pentachloride and that the amount of pyrazinecarboxylic acid was changed to 10.2 g (81.8 mmol), to obtain 890 mg of a powdery catalyst precursor (6) (hereinafter also referred to as a “catalyst (c6)”). The mass of a powder for burning obtained in this process was 4.27 g.

Further, a single cell was produced by the above-mentioned procedure using the catalyst (c6) and was evaluated.

The evaluation results of the catalyst (c6) are listed in Table 1.

### Example 6

A catalyst precursor (6) was produced by the same method as in Comparative Example 6.

The same operation as in Example 1 was carried out, except that the catalyst precursor (1) was changed to 834 mg of the catalyst precursor (6) and that the amount of concentrated hydrochloric acid was changed to 30 ml, to produce 516 mg of a catalyst (6).

Further, a single cell was produced by the above-mentioned procedure using the catalyst (6) and was evaluated.

The evaluation results of the catalyst (6) are listed in Table 1.

### Comparative Example 7

The same operation as in Comparative Example 1 was carried out, except that 2.75 g of copper dichloride was changed to 2.56 g (13.5 mmol) of titanium tetrachloride, that the amount of pyrazinecarboxylic acid was changed to 10.2 g (81.8 mmol), and that the amount of iron(II) acetate was changed to 71 mg (0.41 mmol), to obtain 323 mg of a powdery catalyst (c7). The mass of a powder for burning obtained in this process was 3.21 g.

Further, a single cell was produced by the above-mentioned procedure using the catalyst (c7) and was evaluated.

The evaluation results of the catalyst (c7) are listed in Table 1.

### Comparative Example 8

A zirconium solution (4) was prepared in the same manner as in Comparative Example 4.

In a beaker, 200 ml of water, 160 ml of ethanol, and 200 ml of acetic acid were put; and while stirring them, 11.98 g (96.0 mmol) of pyrazinecarboxylic acid and 5 ml of a 5% NAFION (registered trademark) solution (DE521, DuPont) were added thereto, and 44 mg (0.251 mmol) of iron(II) acetate was added thereto little by little and dissolved over around 10 minutes. Then, with the temperature kept at room temperature and stirring, the zirconium solution (4) was dropwise added over 10 minutes to obtain a solution (c8).

The same operation as in Comparative Example 4 was carried out, except that the mixture (4) was changed to the solution (c8), to obtain 318 mg of a powdery catalyst (c8). The mass of a powder for burning obtained in this process was 2.95 g.

Further, a single cell was produced by the above-mentioned procedure using the catalyst (c8) and was evaluated.

The evaluation results of the catalyst (c8) are listed in Table 1.

TABLE 1

| | | | | | | | | | | | | | Inclination of | |
|---|---|---|---|---|---|---|---|---|---|---|---|---|---|---|
| | | | | | | | | | | | | | Voltage Drop | |
| | | | | | | | | | | | | | (mV/hr) | |
| | | | | | | | | | | | | | (Voltage Drop | |
| | | | | | | | | | | | | | Rate between 5 | Cell Voltage (V) |
| | Proportion of the Number of Atoms | | | | | | | | | | | BET Specific | hr and 20 hr | 20 hr after |
| | (The total of M1, M2, and M3 is set at 1.) | | | | | | | | | | | Surface Area | after Starting | Starting |
| | M1 | | M2 | | M3 | | C | N | O | S | F | (m²/g) | Operation) | Operation |
| Comp. Ex. 1 | Cu | 0.96 | Fe | 0.04 | | | 1.19 | 0.07 | 0.53 | 0.002 | 0.0004 | 273 | 1.88 | 0.630 |
| Example 1 | Cu | 0.41 | Fe | 0.59 | | | 77.08 | 4.24 | 37.09 | 0.082 | 0.014 | 787 | 0.80 | 0.710 |
| Comp. Ex. 2 | Cu | 0.75 | Fe | 0.06 | Na | 0.19 | 1.03 | 0.08 | 0.83 | 0.006 | 0.003 | 141 | 9.10 | 0.330 |
| Example 2 | Cu | 0.51 | Fe | 0.49 | Na | 0 | 118.24 | 8.89 | 37.34 | 0.931 | 0.089 | 804 | 5.40 | 0.592 |
| Comp. Ex. 3 | Cu | 0.69 | Fe | 0.09 | Ti | 0.22 | 1.44 | 0.13 | 0.74 | 0.004 | 0.001 | 220 | 2.04 | 0.288 |
| Example 3 | Cu | 0 | Fe | 0.03 | Ti | 0.97 | 6.74 | 0.47 | 1.72 | 0.029 | 0.002 | 390 | 1.95 | 0.587 |
| Comp. Ex. 7 | | | Fe | 0.03 | Ti | 0.97 | 6.77 | 0.43 | 1.78 | 0.02 | 0.002 | 276 | 5.70 | 0.484 |
| Comp. Ex. 4 | Cu | 0.74 | Fe | 0.08 | Zr | 0.19 | 1.50 | 0.07 | 0.65 | 0.004 | 0.002 | 166 | 4.30 | 0.350 |
| Example 4 | Cu | 0.005 | Fe | 0.03 | Zr | 0.96 | 7.30 | 0.30 | 2.99 | 0.010 | 0.005 | 349 | 2.20 | 0.626 |
| Comp. Ex. 8 | | | Fe | 0.03 | Zr | 0.97 | 7.35 | 0.28 | 2.98 | 0.013 | 0.004 | 289 | 5.80 | 0.532 |
| Comp. Ex. 5 | Cu | 0.77 | Fe | 0.08 | Zn | 0.008 | 5.65 | 0.20 | 1.56 | 0.11 | 0.001 | 368 | 2.70 | 0.544 |
| Example 5 | Cu | 0.34 | Fe | 0.63 | Zn | 0.032 | 102.44 | 2.93 | 26.83 | 0.267 | 0.014 | 583 | 2.00 | 0.629 |
| Comp. Ex. 6 | Cu | 0.7 | Fe | 0.07 | Ta | 0.23 | 1.31 | 0.22 | 0.60 | | | 125 | 7.30 | 0.242 |
| Example 6 | Cu | 0.004 | Fe | 0.05 | Ta | 0.95 | 4.77 | 0.90 | 2.26 | | | 208 | 4.10 | 0.512 |

The single cell of Example 1 has a high cell voltage 20 hours after starting the operation, and a low inclination of the voltage drop, compared to Comparative Example 1.

The cell voltages in the single cells of the examples were also higher 20 hours after starting the operation when Comparative Examples 2 to 6 and Examples 2 to 6 were compared, respectively. Further, the inclinations of the voltage drops in the examples were equivalent to or lower than those of the comparative examples.

The single cell of Example 3 has a high cell voltage 20 hours after starting the operation, and a low inclination of the voltage drop, compared to Comparative Example 7 in which the catalyst (c7) having the composition substantially equivalent to that of the catalyst (3) and obtained without subjected to the contact step was used. The same also applied in comparison between Example 4 and Comparative Example 8.

1. A method for producing a fuel cell electrode catalyst, comprising:
a step of preparing a catalyst precursor comprising each atom of a metal element, carbon, nitrogen, and oxygen, and comprising copper as the metal element; and
a contact step of bringing the catalyst precursor and an acid solution into contact with each other to obtain a catalyst.

2. The method for producing a fuel cell electrode catalyst according to claim 1, wherein 10 to 99 mol % of the metal element is copper.

3. The method for producing a fuel cell electrode catalyst according to claim 1, further comprising iron as the metal element.

4. The method for producing a fuel cell electrode catalyst according to claim 3, wherein 1 to 20 mol % of the metal element is iron.

5. The method for producing a fuel cell electrode catalyst according to claim 1, further comprising, as the metal element, at least one selected from the group consisting of sodium, titanium, zirconium, zinc, and tantalum.

6. The method for producing a fuel cell electrode catalyst according to claim 1, wherein the acid solution is an aqueous solution of at least one acid selected from hydrogen chloride, sulfuric acid, citric acid, and acetic acid.

7. The method for producing a fuel cell electrode catalyst according to claim 1, wherein the contact step is carried out under the following conditions:
temperature: 15 to 100° C.;
time: 0.1 to 500 hours; and
acid concentration: 0.01 to 15 N.

8. A fuel cell electrode catalyst produced by the production method according to claim 1.

9. A fuel cell electrode catalyst layer comprising the fuel cell electrode catalyst according to claim 8.

10. An electrode comprising a fuel cell electrode catalyst layer and a porous support layer, wherein the fuel cell electrode catalyst layer is the fuel cell electrode catalyst layer according to claim 9.

11. A membrane electrode assembly comprising a cathode, an anode, and an electrolyte membrane placed between the cathode and the anode, wherein the cathode and/or the anode is the electrode according to claim 10.

12. A fuel cell comprising the membrane electrode assembly according to claim 11.

13. The fuel cell according to claim 12, which is a polymer electrolyte fuel cell.
